(19) United States
(12) Patent Application Publication
(10) Pub. No.: US 2026/0349141 A1
(43) Pub. Date: Nov. 5, 2026

(54) SYSTEM AND METHODS FOR HEAT-RISK ASSESSMENT INCORPORATING FORWARD-LOOKING CLIMATE DATA

(71) Applicant: AT&T Intellectual Property I, L.P., Atlanta, GA (US)

(72) Inventors: Christopher Holle, Richardson, TX (US); Sebastian Guo, Atlantic Highlands, NJ (US)

(73) Assignee: AT&T Intellectual Property I, L.P., Atlanta, GA (US)

(21) Appl. No.: 19/198,394

(22) Filed: May 5, 2025

(51) Int. Cl. G01W 1/00; G06Q 10/10

(52) U.S. Cl. CPC G01W 1/00; G06Q 10/10

(57) ABSTRACT

Aspects of the subject disclosure may include, for example, a heat risk assessment system that integrates forward-looking climate data to evaluate and manage heat-related risks for outdoor workforces. The system utilizes wet-bulb globe temperature (WBGT) as a primary metric, combined with localized environmental factors such as solar irradiance, urban heat island effects, and technician density. By incorporating both historical and predictive climate data, the system provides dynamic heat risk scores that reflect both immediate and long-term heat stress factors. These scores are used to inform and implement heat risk mitigation strategies, enhancing safety and operational efficiency across various industries. The system leverages advanced data processing and data engineering techniques to deliver accurate and actionable insights, ensuring compliance with regulatory standards and improving workforce resilience to environmental heat stress. Other embodiments are disclosed.

### FIELD OF THE DISCLOSURE

The subject disclosure relates to a system and methods for heat-risk assessment incorporating forward-looking climate data.

### BACKGROUND

The increasing frequency and intensity of heat waves, driven by global climate change, pose significant challenges to outdoor workforces, particularly in industries requiring extensive physical labor under high-temperature conditions. Traditional heat risk indices, such as those provided by national weather services, primarily focus on temperature or heat index measurements. Although temperature is a key factor in various scientific and practical applications, including weather forecasting, climate studies, and the operation of heating and cooling systems, it is not a reliable indicator of a heat perception. Humidity significantly affects heat stress by influencing the body's ability to cool itself through the evaporation of sweat. When humidity levels are high, the air contains more moisture, which reduces the rate at which sweat evaporates from the skin. This diminished evaporation impairs the body's natural cooling mechanism, making it feel hotter than the actual air temperature. As a result, high humidity can exacerbate heat stress, increasing the risk of heat-related illnesses such as heat exhaustion and heat stroke.

A heat index is a measure that combines air temperature and relative humidity to estimate how hot it feels to humans. It reflects the perceived temperature, considering the impact of humidity on the body's ability to cool itself through sweat evaporation. As humidity increases, the body's cooling efficiency decreases, making it feel hotter than the actual air temperature. The heat index is commonly used in weather reports to provide guidance on heat stress levels.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications system in accordance with various aspects described herein.

FIG. 2A is a block diagram illustrating an example, non-limiting embodiment of a heat risk assessment system functioning within the communication system of FIG. 1 in accordance with various aspects described herein.

FIG. 2B is a block diagram illustrating an example, non-limiting embodiment of a heat risk scoring system functioning within the communication system of FIG. 1 in accordance with various aspects described herein.

FIG. 2C is a graphic illustrating an example, non-limiting embodiment of a heat risk scoring map obtained from the heat risk assessment system of FIG. 2A in accordance with various aspects described herein.

FIG. 2D is a block diagram illustrating an example, non-limiting embodiment of a heat risk evaluation system functioning within the communication system of FIG. 1 in accordance with various aspects described herein.

FIG. 2E is a block diagram illustrating another example, non-limiting embodiment of a heat risk scoring system functioning within the communication system of FIG. 1 in accordance with various aspects described herein.

FIG. 3A depicts an illustrative embodiment of a heat risk assessment process in accordance with various aspects described herein.

FIG. 3B depicts another illustrative embodiment of a heat risk assessment process in accordance with various aspects described herein.

FIG. 4 is a block diagram illustrating an example, non-limiting embodiment of a virtualized communication network in accordance with various aspects described herein.

FIG. 5 is a block diagram of an example, non-limiting embodiment of a computing environment in accordance with various aspects described herein.

FIG. 6 is a block diagram of an example, non-limiting embodiment of a mobile network platform in accordance with various aspects described herein.

FIG. 7 is a block diagram of an example, non-limiting embodiment of a communication device in accordance with various aspects described herein.

### DETAILED DESCRIPTION

The subject disclosure describes, among other things, illustrative embodiments for heat risk assessments that use wet-bulb globe temperature and climate data to dynamically evaluate and manage heat-related risks for individuals engaged in strenuous outdoor activities, enhancing safety and operational efficiency. Other embodiments are described in the subject disclosure.

One or more aspects of the subject disclosure include a process that includes receiving, by a processing system including a processor, rasterized weather data spanning a geographical region. The process further includes determining, by the processing system, rasterized wet-bulb globe temperature (WBGT) data based on the received climate model data and identifying, by the processor, a group of boundaries defining work regions associated with a human activity. The process further includes clipping, by the processing system, the weather data to these boundaries to yield clipped weather data that includes the temperature data and determining, by the processing system, heat-risk offset data according to the human activity. The process further includes calculating, by the processing system, heat-risk factors based on the clipped weather data and the offset data, combining, by the processing system, these heat-risk factors to obtain a combined heat-risk factor; and generating, by the processing system, heat-risk scores based on the combined heat-risk factor.

In at least some embodiments, the determination of the temperature data further comprises estimating readings from one or more dry-bulb, natural wet-bulb, and black-globe thermometers using a weighted combination. Additional embodiments include, without limitation, performing minimum-maximum normalization on the clipped weather and worker-related data, computing a weighted mean of the normalized variables to form the combined heat risk factor, assigning heat risk scores to each work region based on a quartile ranking system, generating output reports for informing heat risk mitigation strategies, and predicting climate-change conditions by estimating future weather data through general circulation model data. Alternatively, or in addition, some embodiments may involve adjusting the heat risk offset data to incorporate effects such as urban heat islands and tree canopy influences.

One or more aspects of the subject disclosure include a device, including a processing system having a processor and a memory that stores executable instructions. The executable instructions, when executed by the processing system, facilitate performance of operations that include obtaining rasterized weather data spanning a geographical region, determining corresponding wet-bulb globe temperature data and identifying a group of activity regions defined by boundaries associated with a human activity. The weather data is adjusted to these boundaries to yield activity-region-adjusted weather data and heat risk offset data is determined related to the activity. The heat risk factors are evaluated based on the adjusted data and offset data, the factors are combined to produce a combined heat risk factor, and heat risk scores are generated from the combined factor. In at least some embodiments, the operations include performing normalization on the activity-region-adjusted weather data and activity-related variables using predetermined weights that emphasize heat exposure and worker-related factors. Alternatively, or in addition, the operations include one or more of assigning scores based on quartile rankings, predicting climate-change conditions by estimating climate-change weather data, or adjusting the offset data to account for urban heat island effects and tree canopy influences in selected regions.

One or more aspects of the subject disclosure include a non-transitory machine-readable medium having stored program instructions which, when executed by a processing system, facilitate operations. The operations include obtaining rasterized weather data spanning a geographical region, associating wet-bulb globe temperature data with a geographic grid, and determining a group of activity regions defined by boundaries within the grid that are associated with a human activity. The operations further include adjusting the weather data to the boundaries to obtain activity-region-adjusted weather data, determining heat risk offset data corresponding to the activity, and calculating heat risk factors based on the adjusted weather data and the offset data. In at least some embodiments, these factors can be combined to yield a heat risk score. Alternatively, or in addition, the operations further include any combination of predicting climate-change conditions, estimating climate-change weather data, identifying portions of the activity regions that are urban or tree-covered, and/or adjusting the heat risk offset data to incorporate corresponding urban heat island and canopy effects.

Although a heat index can provide a more comprehensive measure of thermal stress on humans that temperature and/or humidity considered alone, such, indices often fail to account for other factors contributing to a complex interplay of factors influencing human heat perception and susceptibility to heat stress. By way of example, such other factors can include one or more of a solar irradiance, so called urban heat island effects, the availability of cooling mechanisms, and so on. As a result, these traditional methods may not provide a comprehensive assessment of heat-related risks, leaving outdoor workers vulnerable to heat illnesses ranging from minor heat cramps to severe heat strokes.

Moreover, existing heat risk assessments typically rely on current environmental conditions, lacking the capability to incorporate forward-looking climate data that could predict future heat risks. This limitation hinders the ability of organizations to proactively manage and mitigate heat-related risks in the context of evolving climate conditions. As industries face increasing regulatory pressures to ensure worker safety, there is a pressing need for a more sophisticated approach that integrates a broader range of environmental and human factors, enabling more accurate and dynamic heat risk assessments.

Disclosed herein are various embodiments of a heat risk assessment system and processes configured to assign risk scores to predetermined locations and/or regions. In more detail, the risk scores can be determined in view of a particular human activity or group of activities as may be susceptible to environmental conditions, such as temperature, humidity and/or solar radiance. For example, human activity may relate to one or more labor categories deemed susceptible to external environmental conditions, such as agriculture, logging, construction, sports, transportation and public safety. Labor categories, such as these, pose particular risks to workers based on a combination of weather-related conditions and physically demanding tasks. It is worth noting here that although the various examples relate to human activity, they can be applied to non-human activity, including machines and/or animals, e.g., livestock. As climate change trends towards a general warming, with more frequent and/or more potent extreme weather events, it is envisioned that any current risks will likely worsen over time.

The example systems and processes disclosed herein relate to heat-related concerns that may affect worker health, productivity and/or general safety. In some embodiments, heat indices can be determined by integrating variables such as solar irradiance, urban heat island effects, and density of individuals engaged in a particular activity under investigation and/or otherwise being monitored. The system uses Wet-Bulb Globe Temperature (WBGT) as the main temperature metric, which is the recommended standard heat measurement by NIOSH. e.g., DHHS (NIOSH) Publication Number 2016-106, entitled “Criteria for a Recommended Standard: Occupational Exposure to Heat and Hot Environments,” OSHA, and ISO. The risk score can be used for both short-term and long-term climate risk assessments, considering future temperature changes. The system aims to reduce heat-related illnesses, improve operational efficiency, and ensure compliance with federal regulations. The Heat risk Assessment System has potential applications across various industries requiring outdoor labor.

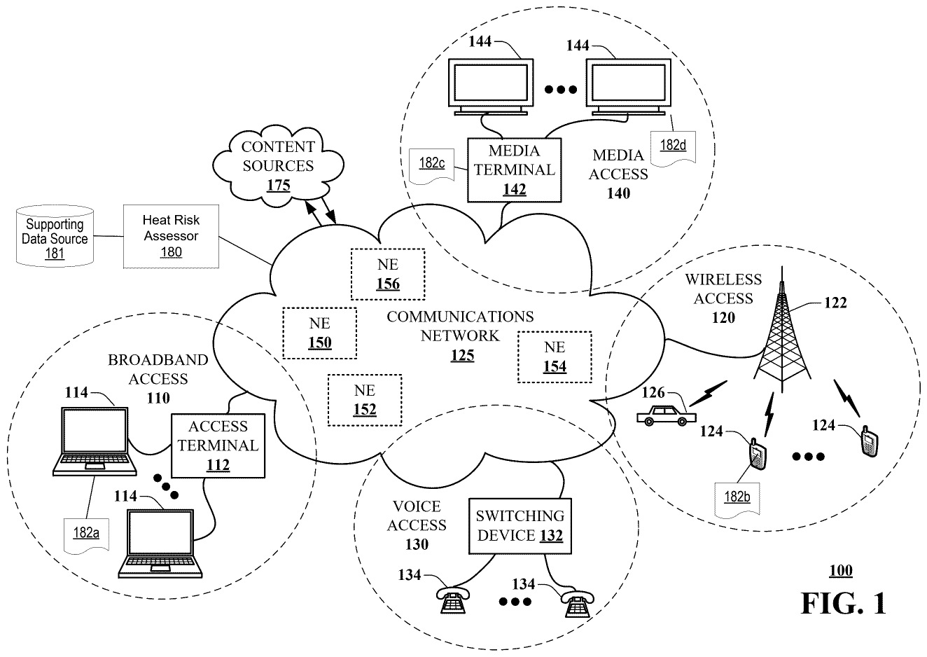

Referring now to FIG. 1, a block diagram is shown illustrating an example, non-limiting embodiment of a communications system 100 in accordance with various aspects described herein. For example, the communications system 100 can facilitate in whole or in part evaluating heat-related risks for individuals engaged in outdoor activities based on wet-bulb globe temperature and climate data. In at least some embodiments, the heat risk assessment leverages data engineering techniques, which may include artificial intelligence and/or machine learning (AI/ML), to dynamically evaluate and manage the heat-related risks, thereby enhancing safety and operational efficiency. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc., for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc., can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

The example communications system 100 includes a heat risk assessor 180 in communication with one or more supporting heat risk assessment data sources 181. In at least some embodiments, the heat risk assessor 180 is configured to include a processing system having one or more processors configured to process data obtained from the one or more supporting heat risk assessment data sources 181 and to determine from the processed data heat risk assessments including one or more indicators of heat risk to one or more human activities. Without limitation, the one or more supporting data sources can provide one or more of weather data, human activity data, geographic locations and/or proximities associated with one or more of the weather data and/or the human activity data. It is envisioned that in at least some embodiments, the heat risk assessments may include a rating and/or a score, such as an index score. For example, an index score may include a limited number of scores to simplify interpretation by consumers of such information. It is envisioned that in at least some embodiments, interpretation may include an action plan that may be based upon a heat assessment score index. By way of example, an action plan may determine a maximum permissible length of time for a particular activity based on the heat assessment score index. Alternatively, or in addition, such an action plan may determine which human activities of a range of activities may be permissible and/or prohibited according to the heat assessment score index. In at least some embodiments, the action plan may identify countermeasures, such as protective gear, cooling gear, hydration plan, and the like.

The supporting one or more supporting heat risk assessment data sources can include environmental data, such as terrain data, facilities data and/or weather-related data. Terrain data may include, without limitation, elevation data, soil content/type data, vegetation data, e.g., tree-cover, and urban coverage. Facilities data can include, without limitation, proximity to manmade shade providers, access to environmentally controlled areas, e.g., air-conditioned areas, and so on. Weather-related data can include, without limitation, one or more of air temperature, solar radiance, humidity, cloud-cover, precipitation, and the like.

It is envisioned that in at least some embodiments, the heat risk assessor 180 may be in communication with consumer systems and/or devices via a network, such as via one or more of the example communications network 125, the example broadband access network 110, the example wireless access network 120, the example voice access network 130 and/or the example media access network 140. In at least some embodiments, the consumer devices can include one or more of the broadband access terminal 112, the data terminals 114, the base station or access point 122, mobile devices 124, vehicles, media terminals 142, display devices 144, switching devices 132 and/or telephony devices 134. For example, one or more of the aforementioned devices may include a heat risk assessment application program or app 182a, 182b, 182c, 182d, generally 182. The heat risk assessment app 182 can be configured to cooperate with the heat risk assessor 180 to provide data to the heat risk assessor 180, and/or to configure a heat risk assessment process implemented by the heat risk assessor 180 and/or to access heat risk assessment results, e.g., heat assessment score index data.

By way of example, the heat risk assessor 180 can be configured to assign risk scores to predetermined locations and/or regions, which in at least some embodiments, can be determined in view of a particular human activity and/or group of activities as may be susceptible to environmental conditions, such as the various example environmental conditions disclosed herein. In at least some embodiments, the heat risk assessor 180 can be configured to account for climate change effects, e.g., trending towards a general warming, with more frequent and/or more potent extreme weather events, it is envisioned that any current risks will likely worsen over time.

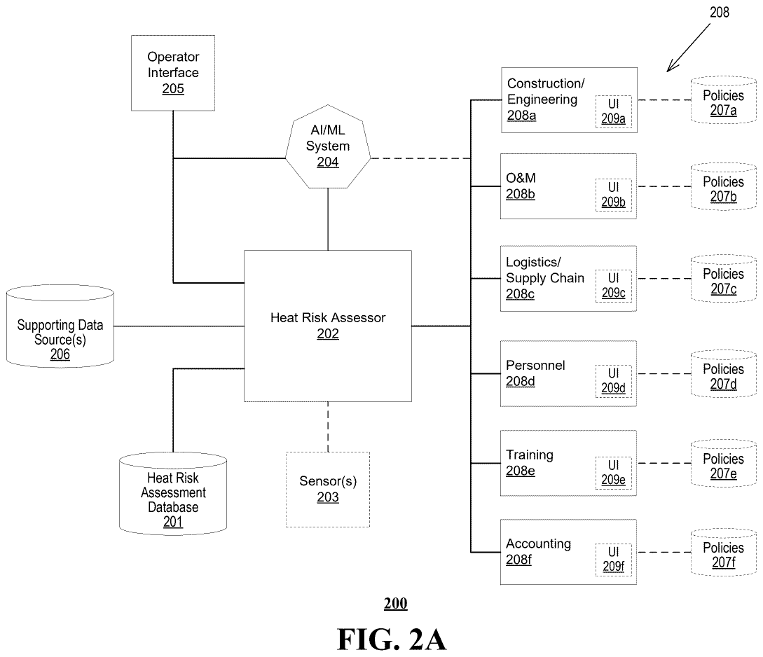

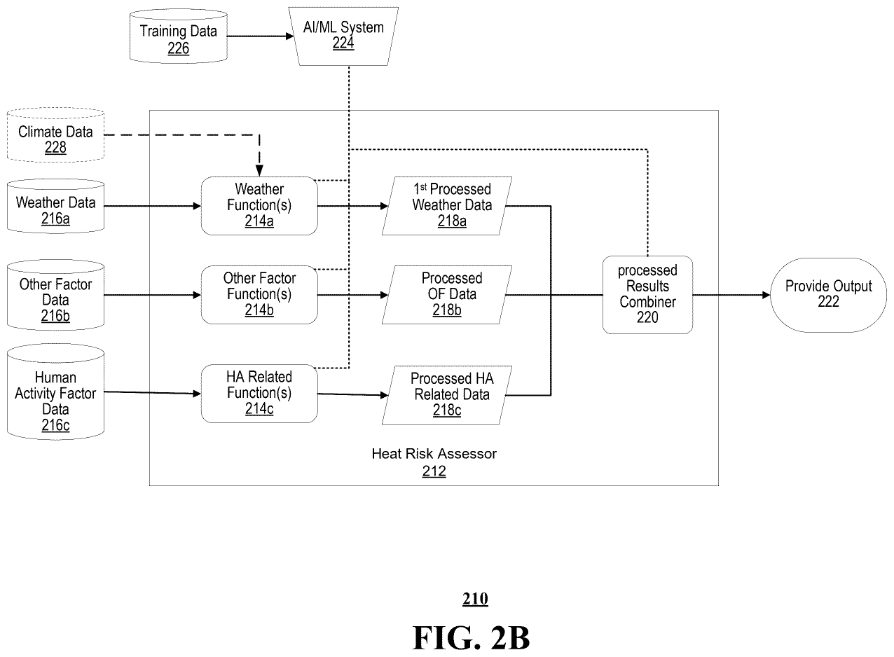

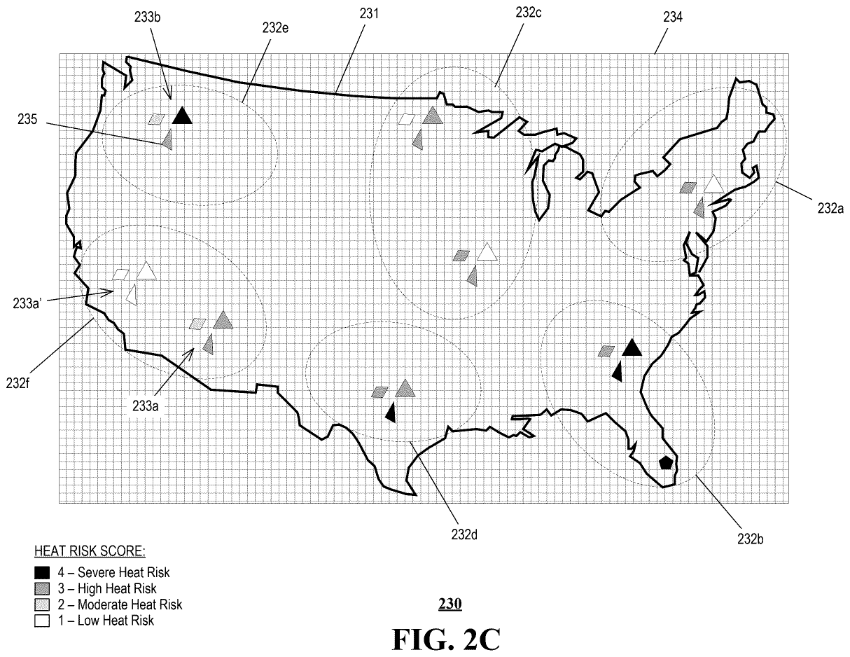

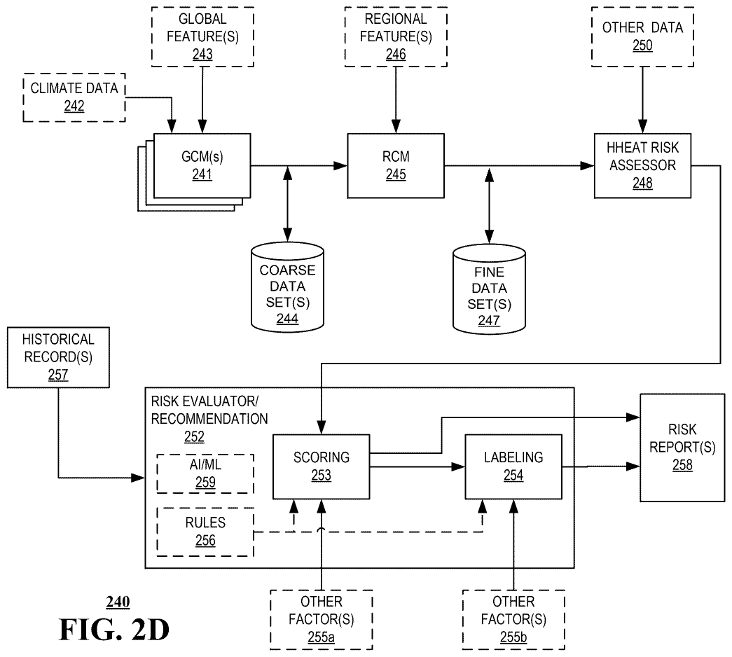

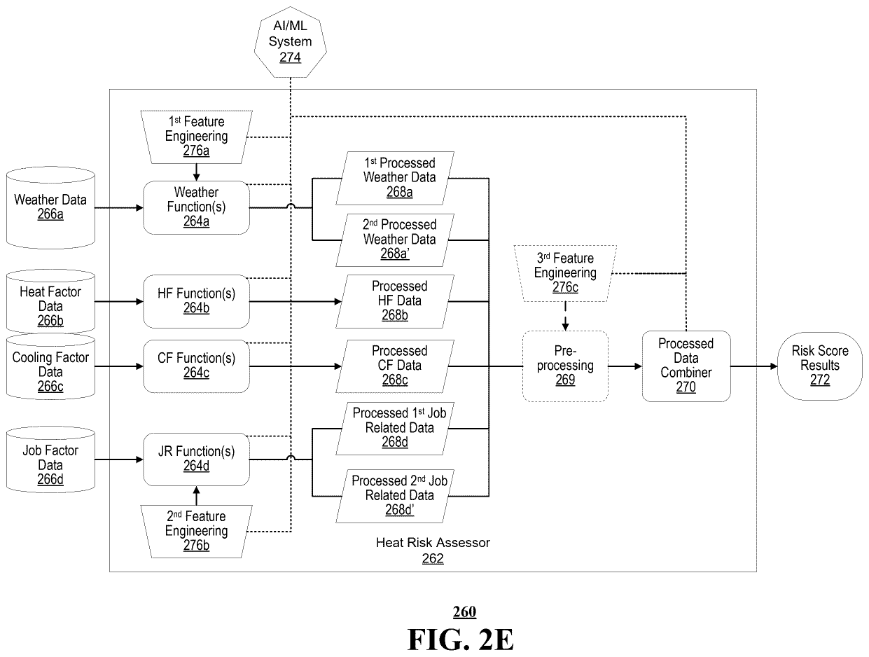

FIG. 2A is a block diagram illustrating an example, non-limiting embodiment of a heat risk assessment system 200 functioning within the communication system 100 of FIG. 1 in accordance with various aspects described herein. The illustrative embodiment of the heat risk assessment system 200 is configured to evaluate and manage heat-related risks across one or more various operational domains. Central to the heat risk assessment system 200 is a heat risk assessor 202, which processes data from one or more supporting data sources 206 to generate a heat risk assessment and/or evaluation. In at least some embodiments, the heat risk assessment can include a heat risk score and/or index. Such heat risk assessments can be provided in one or more formats, such as textual, e.g., tabulated results associated with one or more human activities, geographic locations or combinations thereof. In at least some embodiments, the heat risk assessment is based on a human activity deemed susceptible to heat. Example activities include, without limitation, labor activities, such as construction and/or maintenance of facilities, grounds, e.g., landscaping, roadways and the like, public safety activities, such as police and fire, sports activities, such as athletic training and/or events, e.g., competitions, agricultural activities, such as farming, recreational activities and so on. It is understood that human activities, particularly those that are exposed to environmental conditions, can affect the human condition differently according to the particular environmental conditions.

In at least some embodiments, the heat risk assessment system 200 receives data from one or more supporting data sources 206. For example, the supporting data sources can provide data related to environmental conditions, such as weather data, e.g., including one or more of air temperature, solar radiance, humidity, cloud-cover, precipitation, wind speed, and the like. For example, at least some of the one or more supporting data sources 206 can include weather services, e.g., providing current weather data and/or predicted weather data in the form of forecasts. The weather data can include measured weather data, e.g., as reported by weather stations, weather satellites, weather radars, and the like. In at least some embodiments, one or more of the supporting data sources 206 can provide historical data, and predictive data, and/or combinations of historical and predictive data. Such data can include any of the various examples disclosed herein and/or otherwise understood to relate to environmental conditions and/or human susceptibility to such conditions. In at least some embodiments, at least sone of the one or more supporting data sources 206 provide climate data and/or climate adjusted data, such as climate adjusted historical and/or predictive environmental data. Data obtained from any combination of the one or more supporting data sources 206 can be used in conjunction with real-time data to create comprehensive heat risk profiles. Examples of climate data and/or climate adjusted data can be found in U.S. patent application Ser. No. 18/971,312, entitled “Climate-Change Compensated, Flood-Risk Evaluation System and Method,” incorporated herein by reference in its entirety.

In at least some embodiments, the heat risk assessment system 200 incorporates one or more sensors 203 configured to collect environmental data. The collected environmental data can include any of the various examples disclosed herein and/or otherwise understood to relate to environmental conditions and/or human susceptibility to such conditions real-time environmental data, such as, one or more of air temperature, solar radiance, humidity, cloud-cover, wind speed, precipitation, barometric pressure, a wet-bulb thermometer to measure the lowest temperature that can be reached by evaporating water into the air as may be used in calculating a wet-bulb globe temperature, and the like. By way of example, the one or more sensors 203 may include a thermometer to measure air temperature, an anemometer to measure wind speed, a hygrometer to measure humidity levels in the air, a wind vane to measure wind direction, a barometer to measure atmospheric pressure, a rain gauge to measure an amount of precipitation over a set period, a pyranometer to measure solar radiation. Sensor data obtained from the one or more sensors 203 can be fed into the heat risk assessor 202 to be used alone or in combination with data obtained from the one or more supporting data sources 206 to obtain a processes result as may contribute to and/or otherwise indicate a heat risk assessment. In at least some embodiments, the collected data can include composite data, such as heat index data and/or wet-bulb globe temperature.

In at least some embodiments, the heat risk assessment system 200 includes a user interface 205 in communication with the heat risk assessor 202. The user interface 205 can enable users to interact with the heat risk assessment system 200, e.g., to accept and/or quality check input data and/or to receive and/or otherwise observe output data as may relate to heat risk assessments and/or recommendations based on heat risk assessments. In at least some embodiments, the user interface 205 can include a local device, such as an operator console, a desktop computer, a tablet device, and the like. Alternatively, or in addition, the user interface 205 may be remotely accessible, e.g., via a network, including any of the various network examples provided herein. For example, the user interface may include a portal, e.g., a Web portal accessible via the World Wide Web.

In at least some embodiments, the heat risk assessment system 200 includes one or more artificial intelligence and/or machine learning (AI/ML) modules, such as the example AI/ML system 204. In some embodiments, the AI/ML system 204 operates on data obtained from one or more of the supporting data sources 206, the heat risk assessor 202, one or more sensors 203, or a heat risk assessment database 201. For example, the AI/ML system 204 can be configured to enhance data analysis and/or prediction capabilities, allowing for more accurate assessments of heat risk levels. In at least some embodiments, at least a portion or all of the AI/ML system 204 can be integrated within the heat risk assessor 202. Without limitation, AI/ML system 204 can include one or more of large language models (LLMs, such as GPT-3 and BERT), e.g., based on transformer architectures. Such AI/ML systems can be configured to process and/or generate human-readable text by understanding context and semantics across large datasets. Alternatively, or in addition, the AI/ML system 204 may use different architectures, such as convolutional neural networks (CNNs) for image processing, recurrent neural networks (RNNs) for sequential data, or decision trees for classification tasks. In at least some embodiments, the AI/ML systems 204 include models based on neural networks, e.g., including deep neural networks that include embedded layers. The LLM based AI/ML systems 204 can focus on natural language processing (NLP) tasks, e.g., being well adapted for text generation, translation, summarization, sentiment analysis, and conversational agents. Alternatively, or in addition, other AI/ML configurations can be specialized for specific tasks, such as image recognition, speech processing, predictive analytics, or robotics, each requiring different data types and processing techniques.

It is understood that in operation the AI/ML systems 204 may require a training process. LLM-based AI/ML systems 204 may require text data for training to capture nuances of human language and context. Context, without limitation, may relate to one or more of types of human activities, human conditions, human based susceptibilities, e.g., occupational susceptibilities, environmental conditions, environmental data interpretation, environmental data manipulation, generation of heat risk assessments, generation of heat risk assessment contributors or factors, and/or generation of recommendations for mitigating heat risks.

In at least some embodiments, the heat risk assessment system 200 includes a heat risk assessment data storage device and/or system, such as the example heat risk assessment database 201. It is envisioned that the heat risk assessment database 201 may be in communication with one or more of the heat risk assessor 202, the AI/ML system 204, the one or more sensors 203 and/or the user interface 205. Without limitation, the heat risk assessment database 201 can be configured to store individually and/or in combination, e.g., as may be associated, weather data, heat risk assessment results, user configurations, and/or other parameters as may be related to a heat risk assessment, such as identification of a human activity, a location, a date and/or time period, and so on.

In at least some embodiments, the heat risk assessment system 200 can interface with one or more other systems, e.g., referred to generally as heat risk supported systems 208. By way of illustrative example, the heat risk supported systems 208 can include any combination of construction/engineering systems 208a, operation and maintenance systems 208b, logistics/supply chain systems 208c, personnel systems 208d, training systems 208e, or accounting systems 208f. In at least some embodiments, one or more of the example heat risk supported systems 208 includes policies 207a through 207f, generally 207 (shown in phantom). The policies 207 can relate to the respective heat risk supported systems 208, e.g., providing guidelines related to implementation of heat risk mitigation strategies tailored to specific operational needs. Alternatively, or in addition, the policies 207 can relate to occupational policies, e.g., OSHA guidelines, athletic guidelines as may be imposed by an academic and/or athletic organization, e.g., NCAA guidelines, and so on.

In at least some embodiments, one or more of the heat risk supported systems 208 can supply one or more of the heat risk assessor 202 and/or the AI/ML system 204 with subject matter associated with the one or more heat risk supported systems 208. In at least some embodiments, the heat risk assessor 202 can be configured to provide an assessment that is at least partially based on the subject matter associated with the one or more heat risk supported systems 208. For example, information from construction/engineering systems 208a may include a type of equipment, material and/or construction detail as may have some bearing on a heat risk assessment produced by the heat risk assessor 202. If equipment, materials and/or other construction or engineering details indicate the activity under assessment will increase and/or decrease thermal stress upon an actor, this information can be taken into account by the heat risk assessor 202 in generating the heat risk assessment. Namely, a heat risk assessment may be enhanced and/or otherwise increased based on excess heat and/or thermal radiation produced by equipment used by the actor and/or used in relation to the activity. Information from other heat risk supported systems 208 that may have some bearing on the resulting heat risk assessments may include, without limitation, time of day, levels of personnel training and/or experience, medical records and/or other health indicators, as may be monitored before, during and/or after any activity under assessment, such as body temperature, perspiration, blood pressure, pulse, O₂ level, and so on.

In at least some embodiments one or more of the example heat risk supported systems 208 is equipped with a user interface 209a through 209f, generally 209 (shown in phantom). The user interfaces 209, when provided, may be used to accommodate user requests for heat risk assessments and/or to provide heat risk assessment results. Without limitation, the results may include textual results, e.g., text reports, graphic results, e.g., maps, alarms, recommendations and so on. The user interfaces 209 can include audio capabilities, e.g., to provide audible alarms based on heat risk assessment results and/or to read text-to-speech results of textual heat risk assessment reports. Alternatively, or in addition, the user interfaces 209 can include display terminals and/or other visual indicators, e.g., lights, to present heat risk assessment results and/or to provide visual indicators, e.g., alarms.

Overall, FIG. 2A depicts a sophisticated heat risk assessment system 200 that integrates real-time data collection, advanced analytics, and cross-domain applications to effectively assess and manage heat risks, ensuring safety and operational efficiency across multiple sectors.

FIG. 2B is a block diagram illustrating another example, non-limiting embodiment of a heat risk scoring system 210 functioning within the communications system 100 of FIG. 1 in accordance with various aspects described herein. The illustrative embodiment of the heat risk scoring system 210 is designed to process and evaluate various data inputs to generate a comprehensive heat risk score. The example heat risk assessment system 200is includes a risk assessor 212, which can be configured to orchestrate the data processing and scoring operations. The heat risk assessment system 200 begins by receiving input from multiple data sources, including weather data 216a, other factor data 216b, and human activity factor data 216c.

In at least some embodiments, weather data 216a can include any combination of historical weather data, real-time weather data and/or predicted weather data, e.g., weather forecasts. Weather data 216a can include, without limitation, any combination of one or more weather indicators, such as any of the examples disclosed herein and/or otherwise generally known. Nonlimiting examples of weather data 216a include air temperature, surface temperature, solar radiance, humidity, cloud-cover, e.g., fraction of the sky covered by clouds, often expressed as a percentage, visibility, dew point, UV index, precipitation, barometric pressure, a wet-bulb thermometer to measure the lowest temperature that can be reached by evaporating water into the air as may be used in calculating a wet-bulb globe temperature, and the like.

In at least some embodiments, climate data 228 can include any combination of historical climate data, current climate data and/or predicted climate data, e.g., based on one or more climate models. Climate data 228 can include, without limitation, any combination of one or more climate indicators, such as any of the examples disclosed herein and/or otherwise generally known. Nonlimiting examples of climate data 228 include temperature records, precipitation data, humidity levels, wind patterns, solar radiation, atmospheric pressure, sea surface temperatures, oceanic currents, ice and snow cover, greenhouse gas concentrations and/or climate indices, e.g., metrics, such as El Nino Southern Oscillation index, which describes large-scale climate patterns and their effects.

In at least some embodiments, other factor data 216b can include any combination of factors that contribute to enhancing thermal stress or heating, such as the heat island effect, proximity to black-body radiators, e.g., asphalt roadways, rooftops, dark colored facilities and/or equipment. In at least some embodiments, other factor data 216b contributing to enhancing heat can include heat generated from nearby thermal generators, e.g., equipment representing a subject of the human activity, e.g., equipment being installed, removed and/or otherwise maintained. It is understood that at least some equipment may have a black-body profile that contributes to the heat island effect. It is understood that a black body radiation profile of equipment can provide an indication of an effectiveness of its surfaces and/or materials in absorbing and re-emitting heat. For example, dark-colored surfaces, like asphalt, can act similarly to black bodies by absorbing a significant amount of solar radiation and re-emitting it as heat, contributing to the urban heat island effect. In at least some embodiments, the other factor data 216b can include heat generated by the equipment as may result from any combination of mechanical, chemical and/or electrical processes. Consider electrical equipment that dissipates heat when under power, such as computers, servers, network equipment gasoline and/or diesel engines, open flames as may be encountered during firefighting activities, and so forth. Alternatively, or in addition, other factor data 216b contributing to enhancing heat can include personal equipment worn and/or otherwise utilized by the actors participating in the activity. Examples of personal equipment can include, without limitation, clothing, personal protective gear, tools, machinery, and so on.

Alternatively, or in addition, other factor data 216b can include any combination of factors that contribute to reducing thermal stress or cooling, such as the tree canopy effect, proximity to or lack of equipment capable of reducing heat-related stress, such as air handling equipment, e.g., fans and/or refrigeration, air-conditioning, and so on. Alternatively, or in addition, other factor data 216b contributing to enhancing heat can include personal equipment worn and/or otherwise utilized by the actors participating in the activity, e.g., thermally reflective suits and/or shields.

According to the illustrative example, the heat risk assessor 212 includes one or more groups of functions, such as the example weather functions 214a, other factor functions 214b and human activity related functions 214c, generally heat risk assessment functions 214. The heat risk assessment functions 214 can receive data from one or more data sources and generate processed data that can be combined in a processed results combiner 220. For example, the weather functions 214a may receive weather data 216a from a weather data system and/or weather data repository. In at least some embodiments, the weather functions 214a may receive climate related data, such as climate conditions and/or climate-adjusting offsets as may be applied to other data, such as the example weather data 216a. The weather functions 214a, in turn, generate processed weather data 218a based at least in part on the weather data 216a and/or the climate data 228. Similarly, the other factor functions 214b may receive weather data 216a from a weather data system and/or weather data repository. Similarly, the other factor functions 214b may receive other factor data 216b from another factor data source 216b and/or another factor data repository. In at least some embodiments, the other factor functions 214b may receive data related to heat acceleration factors and/or cooling factors. The other factor functions 214b, in turn, generate processed other factor data 218b based at least in part on the other factor data 216b. Likewise, the human activity factor functions 214c may receive human activity factor data 216c from the human activity factor data source 216c and/or a human activity data repository. In at least some embodiments, the human activity factor functions 214c may receive data related to human activity factors, e.g., demographics, numbers and/or density of humans within a heat risk assessment region. The human activity factor functions 214c, in turn, generate processed human activity factor data 218b based at least in part on the human activity factor data 216c.

Accordingly, data from the weather data source 216a and/or climate data from the climate data source 228 is transformed by the weather functions 214a into processed weather data 218a, the data from the other factor data source 216b is transformed by the other factor functions 214b into processed other factor data 218b, and data from the human activity factor data source 216c us transformed by the human activity related functions 214 c into processed human activity related data 218c. These processed datasets are combined in the combine processed results module 220, which integrates the various data streams to produce a unified assessment of heat risk. Finally, in at least some embodiments, the system provides a heat risk assessment output 222, e.g., in the form of a heat risk score. It is envisioned that an output or score can be used to inform and implement heat risk mitigation strategies either manually, automatically or in a combination of manual and automation. It is further envisioned that the unified assessment of heat risk can be provided in any suitable form as a processed output 222. For example, the processed output 222 may include processed results in the form of a graphic illustration, e.g., a geographical map depicting affected areas, a heat-rise assessment graph, a textual report, a video report, an audio report, an alarm, and so on.

In at least some embodiments, the heat risk scoring system 210 includes an AI/ML system 224. The AI/ML system 224 may be configured as a substantially independent system in communication with one or more of the data sources 216, the functions 214, the processed data sets 218 and/or the processed results combiner 220. Alternatively, or in addition, the AI/ML system 224 can be integrated partially or wholly within the heat risk assessor 212, e.g., as a dedicated AI/ML system 224. In at least some embodiments, the AI/ML system 224 can be configured utilizes training data 226 and/or climate data 228 to enhance the accuracy and predictive capabilities of the heat risk scoring process.

Overall, FIG. 2B depicts a sophisticated system that leverages advanced data processing and machine learning techniques to deliver accurate and actionable heat risk assessments.

FIG. 2C is a graphic illustrating an example, non-limiting embodiment of a heat risk map 230 obtained from the heat risk assessment system 200 of FIG. 2A in accordance with various aspects described herein. The heat risk map 230 shows a geographic region, e.g., the continental United States, contained within a geographic boundary 231, e.g., the U.S. boarder, overlaid upon a grid 234. In at least some embodiments, e.g., when the geographic region is particularly large, and/or for other practical reasons, such as for business organizational and/or management efficiencies, the heat risk map 230 can include one or more heat risk managed regions that reside at least partially within the geographic boundary 231. For example, such heat risk managed regions may be determined according to a user requirement, e.g., a user resource management strategy that may distinguish a large region, e.g., the continental U.S. into a group of sub-regions. Here, the example sub-regions include a northeast heat risk managed region 232a, a southeast heat risk managed region 232b, a north central heat risk managed region 232c, a south-central heat risk managed region 232d, a northwest heat risk managed region 232e and a southwest heat risk managed region 232f.

Each of the example heat risk managed region 232a through 232f, generally 232, may include one or more heat risk managed facilities and/or areas contained within and/or otherwise associated with the heat risk managed region 232. According to the illustrative example, the northwest region 232b includes a group of heat risk managed areas 233b. Each individual heat risk area can be defined by a bounding perimeter 235, e.g., according to the illustrated perimeters shown as polygons. For example, the heat risk managed areas of the example group of heat risk managed areas 233 may include geographic regions, e.g., municipalities, towns, counties, neighborhoods. Alternatively, or in addition, the bounding regions may include a campus, a farm, a forest, a shopping area and/or any other commercially relevant region. For example, the heat risk managed areas of the example group of heat risk managed areas 233 may correspond to wire centers of a telecommunications service provider and/or their respective serviced territories. Such wire centers may correspond to managed regions served by a particular occupational group, e.g., linesmen, laborers, technicians, operators, and so on.

It is envisioned that in at least some embodiments, the example heat risk map 230 may be prepared for a target population, such as a particular occupational group and/or some combination of such groups. For example, certain occupational groups and/or demographic groups may be more susceptible to environmental conditions than others. Consider laborers who may be involved in heavy construction may be more susceptible to a particular heat risk than technicians who may be, on average, involved in less strenuous activities. In such instances, the heat risk scores may take this into account. Likewise, certain demographic groups, as may be distinguished by any demographic indicator, such as age, gender, income, education, and/or occupation. Similarly, certain types and/or categories of equipment as may be installed and/or otherwise maintained by any of the example data centers, may exhibit material susceptibilities to environmental conditions. Alternatively, or in addition, certain types and/or categories of equipment may expose personnel who may be installing, maintaining and/or otherwise servicing such equipment to relates susceptibilities. Consider heat-generating equipment, heavy equipment, equipment installed in restricted workspaces, and so on. In such instances, a first heat risk map 230 may be prepared for a first target population, having a first scale, while a second heat risk map may be prepared for a second target population, having a second scale which may be the same or different.

It is envisioned that in at least some embodiments, the heat risk map 230 may include visual indicators associated with a heat risk assessment result, e.g., a heat risk metric or score. According to the illustrative example, the heat risk scores can range from a score of “1,” indicating a low heat risk, to a score of “2,” indicating a moderate heat risk, to a score of “3,” indicating a high heat risk, and to a score of “4,” indicating a severe heat risk. The heat risk metrics or scores can be associated with a fill pattern, a shading and/or a color, such that the heat risk managed areas of the example group of heat risk managed areas 233 as defined by their respective perimeters may be coded accordingly.

It is understood that heat risk assessments can be based on one or more contributing factors, such as environmental conditions, a nature and/or duration of the evaluated human activity, indicators of human perceptibility, which may differ by demographic and/or region. For example, a relatively high temperature may be more ready tolerated by human actors operating in southern regions 232b, 232d, 232f, when compared to comparable human actors operating in norther regions 232a, 232c, 232e, e.g., based on personal acclimations, and the like.

According to the illustrative example, the group of heat risk managed areas 233b of the northwestern heat risk managed region 232 e include heat risk scores ranging from 2-4. The southwest heat risk managed region 232f includes a first group of heat risk managed areas 233a having heat risk scores ranging from 2-3 and a second group of heat risk managed areas 233 b having heat risk scores of 1. Heat risk scores may vary according to time of day, day of week, season, weather conditions, occupational workload, applicable policies, and so on.

FIG. 2D is a block diagram illustrating an example, non-limiting embodiment of a heat risk evaluation system 240 functioning within the communication system 100 of FIG. 1 and/or the heat risk scoring system 210 of FIG. 2B in accordance with various aspects described herein. The example heat risk evaluation system 240 includes one or more global climate models 241 configured to provide climate-adjusted weather data according to one or more climate conditions. Weather data can include one or more weather indicators, such as temperature, e.g., average global temperature, wind speeds, changes in ocean currents, sea level rise, precipitation patterns, snowfall, ice sheet extent, cloud cover, humidity levels, extreme weather event frequency and so on. Models output data on a grid system, providing information for specific locations across the globe. Outputs can include mean values, e.g., average rainfall, variability, temperature, e.g., standard deviation of rainfall and/or temperature, and extreme events, e.g., frequency and/or severity of heatwaves and/or periods of extreme rainfall. As the techniques disclosed herein relate to heat risk, weather indicators related to heat related factors are of particular interest. Heat related data may include temperature, solar radiance, humidity over some reporting period, e.g., one hour, or some number of hours and/or days as may be useful to determine total atmospheric contributions to heat risk over some examination period and/or periods.

In at least some embodiments, the global climate model(s) 241 receives climate data 242 and/or global features 243. Climate data may include any of the various examples provided herein and/or otherwise known to those familiar with examining current and/or changing climate conditions. Global conditions can include conditions or factors, such as radiation, temperature, humidity, wind patterns, ocean currents, sea ice, land surface processes, urban development and so on.

In more detail, climate data can include, without limitation, current and/or historical climate conditions, e.g., actual and/or observed climate conditions. Alternatively, or in addition, climate data can include estimated and/or otherwise predicted or projected future climate conditions. Future climate conditions can be used to simulate climate-adjusted weather data under one or more different future climate conditions. Representative concentration pathways (RCPs) relate to climate change scenarios in which future greenhouse gas concentrations and/or other pollutants are used to evaluate the potential consequences of different climate change scenarios. There are multiple RCP scenarios, in which different greenhouse gas concentrations and radiative forcing are projected. For example, some RCP scenarios may represent a low emission scenario with limited climate change, other RPCs may represent other scenarios with moderate emissions expected to peak, while still other scenarios consider a high-emission scenario as may be experienced if efforts are not undertaken to curtail emissions. For example, a “business as usual” RCP scenario can be used to model potential consequences of insufficient action against climate change, such as increased reliance on fossil fuels and significant ecological challenges.

Examples of global climate models include: energy balance models (EBMs), which are the simplest type, intermediate complexity models (EMICs) that incorporate more geographical features like land and oceans, and general circulation models (GCMs), the most complex and precise models that simulate the full atmosphere-ocean system, often used to predict climate change with high detail; all of these models are considered “global climate models” and are used by scientists to study the Earth's climate system. Specific examples include, without limitation, the NCAR CESM (Community Earth System Model): Developed by the National Center for Atmospheric Research, GFDL CM (Geophysical Fluid Dynamics Laboratory Climate Model): Operated by NOAA's Geophysical Fluid Dynamics Laboratory, MPI-ESM (Max Planck Institute Earth System Model): Developed by the Max Planck Institute for Meteorology, or the IPSL (Institut Pierre Simon Laplace Climate Modelling Centre): A prominent European climate model. In at least some embodiments, the climate models include earth system models (ESMs) that incorporate complex interactions between two or more of the atmosphere, ocean, land surface, and/or carbon cycle. Examples include, without limitation, one or more of three prominent examples of global climate models in the Coupled Model Intercomparison Project 5 (CMIP5). More particularly, these models include the Community Climate System Model ver. 4 (CCSM4), the Geophysical Fluid Dynamics Laboratory (GFDL) models, e.g., CM4, SPEAR, CM3, CM2.5 and FLOR, and the Hadley Centre Global Environmental Model (HadGEM) model. These example models represent good representation of the 40 global climate models in CMIP 5.

Climate-adjusted weather data can be obtained according to a summary process, e.g., a temperature summary, in which the temperature data may be summarized according to certain conditions and/or time periods. For example, the temperature data may be summarized according to particular climate conditions, e.g., an RCP, and at various time periods, e.g., mid-century mean, end-of-century mean, historical maximum, mid-century (2045-2054) maximum and/or end-of-century (2085-2094) maximum precipitations. In at least some embodiments, the summary results may be obtained according to particular time periods, e.g., particular months and/or seasons. In at least some embodiments, climate-adjusted weather data may be obtained from more than one global climate model and combined to obtain a combined result, e.g., according to a blend and/or average result. The results facilitate the examination of changes in intensity, duration, and frequency of heatwaves, which, in turn, can be used to evaluate consequential heat related risk factors.

In at least some embodiments, outputs based on one or more of the global climate models 241, e.g., climate-adjusted weather data can be stored in a repository, such as the example coarse data set repository 244. The outputs based on the one or more of the global climate models 241, e.g., coarse climate-adjusted weather data sets from the coarse data set repository 244 may be provided as inputs to a regional climate model 245. In at least some embodiments, the regional climate model generates climate-adjusted weather data, e.g., precipitation data, according to a finer spatial resolution. For example, the regional climate model 245 can be configured to perform a dynamic downscaling of the coarse climate-adjusted weather datasets.

By way of example, the regional climate model 245 can apply one or more land surface models. Land surface models provide mathematical representations of physical and biogeochemical processes that occur at the Earth's surface and in the atmosphere, e.g., simulating an exchange of energy, water, momentum, and/or trace gases between the land and the atmosphere. It is understood that in at least some embodiments, the regional climate model 245 obtains regional feature data 246 as may be relevant in performing the dynamic downscaling operations. Regional features can include conditions or factors, such as radiation, temperature, humidity, wind patterns, ocean currents, sea ice, land surface processes, urban development, tree cover, soil composition, and so on. In at least some embodiments, outputs based on one or more of the global climate models 241, e.g., climate-adjusted weather data can be stored in a repository, such as the example coarse data set repository 244. The regional climate model 245 provides outputs based on an application of one or more regional climate models, e.g., land surface models, to obtain refined climate-adjusted weather data sets, e.g., providing a finer spatial resolution than would otherwise be available from the coarse data sets. In at least some embodiments, the refined regional climate-adjusted weather data sets may be stored in a fine data set repository 247.

In at least some embodiments, the heat risk evaluation system 240 includes a heat risk assessor module 248 configured to convert raw data, e.g., raw climate data into heat risk data, e.g., wet-bulb globe temperature (WBGT) data. For example, the heat risk assessor module 248 can include one or more models, e.g., one or more estimation models that can be configured to leverage and/or otherwise utilize so-called raw data to obtain heat risk data. In at least some embodiments, the heat risk assessor module 248 facilitates coupling of estimation models with atmospheric models, e.g., the regional climate model 245 and/or the global climate models 241. It is envisioned that in at least some embodiments, the heat risk assessor module 248 may include at least some of the modules and/or functionalities provided by the heat risk scoring systems 210. e.g., the heat risk assessor 212 (FIG. 2B). In at least some embodiments, raw data can include data obtained from the regional climate model 245. In at least some embodiments, data from the regional climate model 245 includes dynamically downscaled data as may be provided as input to determination of a heat risk, such as wind speed and/or direction, wind gust data, temperature, humidity, wet bulb temperature, solar irradiance, atmospheric pressure, etc. In at least some embodiments, output data of the heat risk assessor module 248 can be provided as gridded time series, as can be said for any of the various data disclosed herein, e.g., climate-adjusted atmospheric data, short-term weather forecast data, sensor data, terrain data, heat risk evaluation data, e.g., WBGT data, heat risk scores, risk labels, and the like.

In at least some embodiments, the heat risk evaluation system 240 includes other input data from one or more other data sources 250 (shown in phantom). It is envisioned that in at least some embodiments, the heat risk assessor module 248 may receive input data from the other data source(s) 250 that can be used alone or in combination with data obtained from the regional climate model 245 to obtain heat risk data. Input data from the other data source(s) 250 can include any of the examples disclosed herein and/or otherwise generally known to those skilled in the art. For example, the other input data from the other data source(s) 250 can include data obtained from one or more sensors, sensor monitoring systems, and/or sensor data repositories. In at least some embodiments, sensor data may be obtained from one or more sensor devices configured to monitor environmental conditions, e.g., temperature, wet-bulb temperature, humidity, atmospheric pressure, solar irradiance, wind speed and/or direction. In some embodiments, the other input data may include any combination of one or more of environmental data and/or climate data related to current conditions, and/or to prior conditions, e.g., historical records, and/or to future conditions as may be obtained from a prediction and/or forecast. Alternatively, or in addition, the other input data from the other data source(s) 250 may include meteorological observational data and/or data obtained from weather forecast models. Such forecasts can include, without limitation, precipitation forecasts, temperature forecasts, solar irradiance forecasts, wet-bulb temperature forecasts, e.g., according to one or more of an 18-hour forecast, a 10-day forecast and/or a 30-day ensemble forecast. To the extent climate-adjusted data is considered, e.g., from the regional climate model 245 and/or the global climate models 242, the weather forecast may be adjusted according to a climate shift factor, e.g., based on differences in weather data projections under different climate conditions. It is understood that forecasted parameters may be leveraged, e.g., combined, to obtain heat risk data, such as the example WBGT data.

The heat risk assessor module 248 can be configured to provide relevant data, e.g., WBGT data and/or other data that contribute to determination of a WBGT. In at least some embodiments, these data are provided according to a spatial grid and/or a spatio-temporal grid over the region of interest based on one or more of the aforementioned inputs. For example, to the extent the heat risk assessor module 248 includes an estimation model, that model can be configured to provide WBGT data and/or data for WBGT contributing factors, e.g., according to a spatial grid and/or a spatio-temporal grid over the region of interest based on one or more of the aforementioned inputs. It is understood that the heat risk data may be applicable to long-term planning and/or for preparation and/readiness for short-term events, e.g., heatwave events as may be indicated by data provided by a weather forecast model. These data may provide information indicating heat risk factor model hazard zones, community boundaries and names, availability of shade, access to fluids, e.g., potable water, and/or artificial cooling, e.g., fans, air conditioning, structures, e.g., environmental shelters, etc. Such information may be used to enhance a confidence and/or to adjust predicted heat risk factor data. For example, heat risk factor data may be reduced to the extent heat risk mitigation factors, e.g., structures or shelters are identified.

In at least some embodiments, the heat risk evaluation system 240 includes a risk evaluator and-or recommendation process module 252. The risk evaluator and or recommendation process module 252 can be configured to generate one or more risk reports, e.g., risk scores, risk labels and/or recommendations, which may be provided in the form of reports 258 and/or user accessible datasets. According to the illustrative example, the risk evaluator and/or recommendation process module 252 includes a scoring module 253. The scoring module 253 is configured to receive an input from the heat risk factor model 248, e.g., in the form of heat risk data, e.g., data providing WBGT and/or contributing factors. As indicated, this may include heat risk data according to a spatial grid and/or a spatio-temporal grid. The scoring module 253 can be configured to apply a scoring methodology and/or a classification to obtain heat risk score data based on the heat risk data. The scoring process can include any of the various examples disclosed herein and/or otherwise generally known. Once again, the heat risk score data may be provided according to a spatial grid and/or a spatio-temporal grid.

In at least some embodiments, the risk evaluator and/or recommendation process module 252 includes a labeling module 254. The labeling module 254 is configured to receive an input from the scoring module 253 and to apply a labeling methodology and/or a classification to obtain heat risk label data. The labeling process can include any of the various examples disclosed herein and/or otherwise generally known. Once again, the heat risk label data may be provided according to a spatial grid and/or a spatio-temporal grid. It is worth noting here that at any point in the example processes disclosed herein, it is understood that data provided according to one grid system may be translated and/or otherwise transformed into another grid system.

In at least some embodiments the risk evaluator and/or recommendation process module 252 may apply one or more rules, e.g., business rules 256 to one or more of the scoring process and/or the labeling process. Example business rules 256 (shown in phantom) may be provided as inputs to one or more of the scoring module 253 and/or the labeling module 254. It is envisioned that, in at least some embodiments, the scoring module 253 may receive supporting information, e.g., in the form of other factors 255a (shown in phantom) as may be useful in applying a scoring methodology. Likewise, in at least some embodiments, the labeling module 254 may receive supporting information, e.g., in the form of other factors 255b (also shown in phantom) as may be useful in applying a labeling methodology.

In at least some embodiments the risk evaluator and/or recommendation process module 252 may apply historical observations, e.g., according to historical records 257, to one or more of the scoring process and/or the labeling process. It is further envisioned that artificial intelligence (AI) and/or machine learning (ML) may be applied to any of the various procedure, processes and/or techniques disclosed herein. For example, the risk evaluator and/or recommendation process module 252 may include an AI/ML module 259 configured to apply an AI model to one or more of the scoring and/or labeling processes. To this end, the AI/ML module may receive input data from the historical records to perform a training process in which previously generated scoring and/or labeling data may be used. Namely, the AI/ML model may be allowed to generate a result, e.g., a score and/or a label based on input data, such as heat risk data, location data, facility data, heat risk score data and the like.

According to a training process, predictions generated by the AI/ML module 259 may be compared against actual observations, resulting in an error value which may be provided to the AI/ML module 259 in accordance with the training process. The AI/ML module 259, e.g., a neural network, such as a deep neural network including hidden nodes, may make adjustments to model values to obtain an updated prediction, which, in turn, may be compared again to obtain an updated error, until the error has fallen below some suitable threshold, in which instance the model can be said to be suitably trained. The trained model may be leveraged by one or more of the scoring module 253 and the labeling module 254 to obtain AI/ML predicted results.

FIG. 2E is a block diagram illustrating another example, non-limiting embodiment of a heat risk scoring system 260 functioning within the communication system 100 of FIG. 1 in accordance with various aspects described herein. The illustrative embodiment of the heat risk scoring system 260 processes various data inputs to generate a comprehensive heat risk score. Central to the system is a module or subsystem referred to herein as a heat risk assessor 262, which manages at least a portion of the data processing and scoring operations. The heat risk scoring system 260 begins by receiving input from multiple data sources. According to the illustrative example, and without limitation, the data sources include a weather data source 266a, heat factor data source 266b, cooling factor data source 266c, and job factor data source 266d, generally, data source 266.

The heat risk assessor 262 includes one or more functions 264a, 264b, 264c, 264d, generally 264, configured to process input data from the data sources 266. For example, weather data obtained from the weather data source 266a can be processed and/or otherwise transformed through weather functions 264a, which can be configured to analyze environmental conditions such as temperature, humidity, heat index and/or wet-bulb globe temperature. Heat factor functions 264b can be configured to process and/or otherwise transform heat factor data related to specific heat stress factors, while cooling factor functions 264c can focus on processing and/or otherwise transforming data concerning cooling mechanisms and their effectiveness. In at least some embodiments, the job factor functions 264d can be configured to process and/or otherwise transform data received from the job factor data source 266d as may be related to job-specific conditions that may influence heat risk.

In at least some embodiments, the processed data can be obtained in more than one separate process or transformation. For example, the weather functions 264a can be configured to transform weather data obtained from the weather data source 266a into first processed weather data 268a and second processed weather data 268a. For example, the first processed weather data 268a may relate to a first weather indicator, such as air temperature, heat index and/or wet-bulb globe temperature. Likewise, the second processed weather data 268a′ may relate to a second weather indicator, such as a different one of air temperature, heat index and/or wet-bulb globe temperature. In at least some embodiments, one or more of the first and second processed weather data 268a, 268a′ may incorporate climate change based on a predetermined climate model and/or evaluation timeframe. Similarly, the heat factor functions 264b can be configured to transform heat factor data obtained from the heat factor data source 266b into processed heat factor data 268b, the cooling factor functions 264c can be configured to transform cooling factor data obtained from the cooling factor data source 266c into processed cooling factor data 268c. In at least some embodiments, the processed job-related functions 268d can be configured to transform job factor data obtained from the job factor data source 266d into first processed job factor data 268d and second processed job factor data 268d. For example, the first processed job factor data 268d may relate to a type of human activity, such as an occupation, e.g., as may be categorized according to occupational regulatory entity, e.g., OSHA. Likewise, the second processed weather data 268a′ may relate to a second job factor indicator, such as a number and/or density of humans associated with the particular occupation under investigation and anticipated as being within and/or otherwise associated with a particular region and/or regions.

In at least some embodiments, one or more of the functions 264 incorporate feature engineering processors 276a, 276b, 276c as may be applied to the respective data sets obtained from a corresponding data source 266 to refine and optimize the data as may be beneficial for scoring. According to the illustrative example, the heat risk assessor 262 includes a first feature engineering processor 276a configured to apply feature engineering to weather data obtained from the weather data source 266a. Similarly, the heat risk assessor 262 includes a second feature engineering processor 276b configured to apply feature engineering to job factor data obtained from the job factor data source 266a. Feature engineering can be employed as a key step in a machine learning pipeline, in which raw data can be transformed into a set of features that can effectively represent the underlying patterns and relationships within the data. The feature engineering process can involve several key activities, starting with data cleaning to remove noise and correct inconsistencies, ensuring the data is accurate and reliable. Alternatively, or in addition, the feature engineering process can include transformation techniques, such as scaling and normalization, as may be applied to adjust data obtained from a data source 266 into a consistent format, making it suitable for model input. In at least some embodiments, feature engineering can also encompass a creation of new features, and/or a leveraging of domain expertise to combine existing data points or derive new variables that capture essential aspects of the problem. Feature selection can be crucial, as it involves identifying and retaining the most informative features while eliminating those that are redundant or irrelevant, thereby enhancing model performance. By carefully crafting and selecting features, feature engineering can significantly improve the accuracy and efficiency of predictive models, reduce the risk of overfitting, and provide clearer insights into the data, ultimately leading to more robust and interpretable machine learning solutions.

In at least some embodiments, the heat risk scoring system 260 includes a processed data combiner 270 configured to combine the processed data 268 from one or more of the functions 264 to obtain a unified heat risk assessment. Alternatively, or in addition, the heat risk scoring system 260 includes a pre-processing module 269 (shown in phantom). The pre-processing module 269 can be configured to further prepare the data, which is then combined in the processed data combiner module 270 to produce a unified heat risk assessment as may be presented as heat risk score results 272. In at least some embodiments, the heat risk assessor 262 further includes a third feature engineering processor 276c configured to apply feature engineering to a preprocessing function of the pre-processing module 269.

In at least some embodiments, the heat risk scoring system 260 includes one or more AI/ML systems 274 configured to enhance the accuracy and predictive capabilities of the scoring process. For example, according to the illustrative example, the heat risk assessor 262 includes and/or is otherwise in communication with an AI/ML system 274. The AI/ML system may monitor, control and/or otherwise support one or more of the feature engineering processors 276, the functions 264, the preprocessing module 269 and/or combination by the processed data combiner.

Finally, the system provides risk score results 272, which can be used to inform and implement heat risk mitigation strategies. Overall, FIG. 2D depicts a sophisticated system that leverages advanced data processing, feature engineering, and machine learning techniques to deliver precise and actionable heat risk assessments.

Referring again to FIG. 2A, it is envisioned that in at least some embodiments, the heat risk assessor 202, the one or more of the heat risk supported systems 208, or any combination thereof may be configured to provide a recommendation based on a heat risk assessment. It is envisioned that such recommendations may be based on one or more metrics, e.g., optimizing one or more of an activity duration, a number of supporting actors, e.g., including shift work in which more actors may be able to complete a task sooner under relatively high heat risk conditions, allowing for breaks and/or recouperation between shifts, while the activity continues. Alternatively, or in addition, cost may be optimized by changing any combination of one or more factors, such as skill level, time of day, protective equipment, and so on. For example, consider an activity that results in a relatively high thermal stress if performed during a certain time of day, e.g., between 10 am and 2 pm when the solar stress is at its greatest and/or depending upon forecast and/or actual weather conditions, e.g., cloud cover. The recommendation may include rescheduling the activity to another time of day and/or day of the week based on forecasted weather conditions. Other examples can include, without limitation, recommending training and/or personal protective gear based on heat risk assessments, recommendations in logistics and/or supply chain, e.g., ordering protective equipment in anticipation of predicted heat risks, whereby adherence to such recommendations may reduce the associated heat risk. In at least some embodiments, a recommendation may indicate a first heat risk assessment under a first set of conditions and/or circumstances, a recommendation and a second heat risk assessment under a second set of recommendation conditions and/or circumstances. In at least some instances, the recommendation may indicate potential savings in time, cost, effort and/or other risks, such as injury.

It is understood that the heat risk assessor 202 and/or heat risk assessment processes disclosed herein can take into account the activities being done and/or the equipment being used, installed and/or repaired and to account for, in at least some instances, heat produced by the equipment. It is further understood that, in at least some embodiments, the heat risk assessor 202 and/or heat risk assessment processes disclosed herein can recommend, initiate and/or otherwise make adjustments. For example, a work schedule to work on particular equipment can be adjusted automatically, such that the work is performed at other times of the day or operation of related equipment is adjusted to reduce the heat based on a heat risk assessment. In at least some embodiments, these adjustments can take into account the effect on performance, such as the performance of a network resulting from a determination that delaying replacing a device during the middle of the day will cause a below threshold performance issue and therefore the device can be replaced at night.

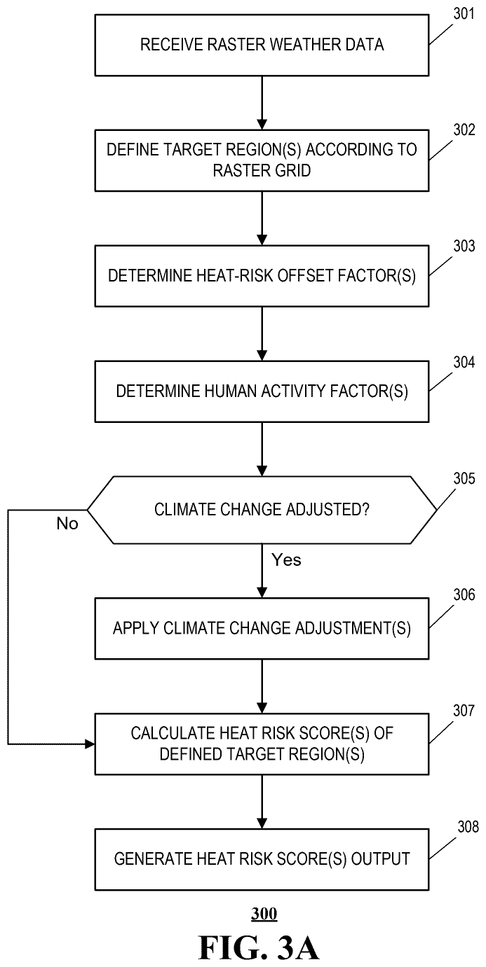

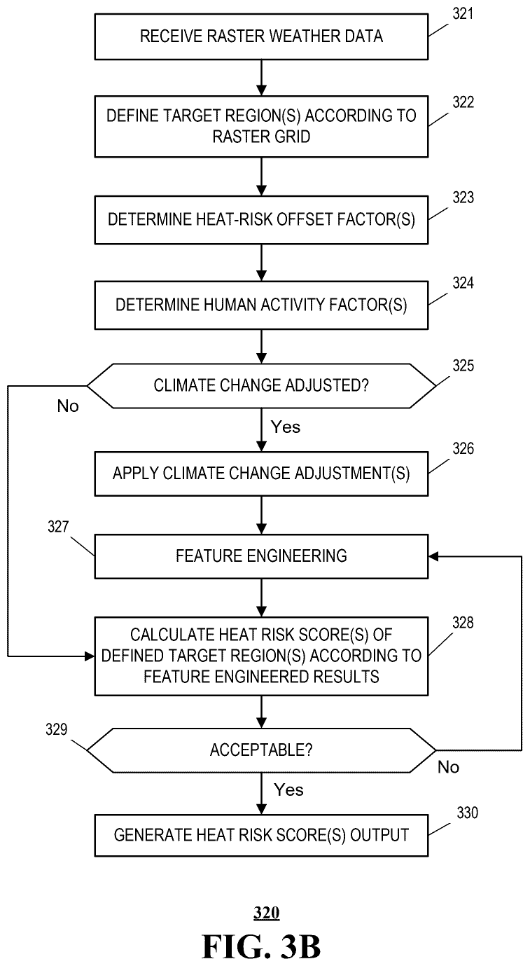

FIG. 3A depicts an illustrative embodiment of a heat risk assessment process 300 in accordance with various aspects described herein. The illustrative embodiment of the heat risk scoring process 300 systematically evaluates and calculates heat risk scores for defined target regions. The example process 300 begins with receiving raster weather data at 301, which provides detailed environmental information across a grid format. The next step involves defining target regions according to the raster grid at 302, ensuring that the analysis is geographically specific.

The example process 300 then determines heat risk offset factors at 303, which may include variables such as solar radiation and humidity that affect heat perception. Human activity factors at 304 are also assessed, focusing on the susceptibility of individuals to heat stress based on their activities.

A decision point is provided at 305 to check whether climate change adjustments are necessary. If adjustments are required, the process applies climate change adjustments at 306 to account for projected changes in environmental conditions. Subsequently, the heat risk scores of the defined target regions are calculated at 307, integrating all relevant data and adjustments.

Finally, the process generates heat risk score outputs at 308, which can be used to inform and implement strategies for mitigating heat-related risks. Overall, FIG. 3A illustrates a structured approach to assessing heat risk, combining environmental data, human factors, and climate projections to deliver actionable insights.

FIG. 3B depicts another illustrative embodiment of a heat risk assessment process 320 in accordance with various aspects described herein. The example heat risk scoring process 320 evaluates and calculates heat risk scores for specified target regions. The example process 320 begins with receiving raster weather data at 321, which provides detailed environmental information in a grid format. The next step is defining target regions according to the raster grid at 322, ensuring that the analysis is geographically specific.

The process then determines heat risk offset factors at 323, such as solar radiation, humidity, and urban heat island effects, which influence heat perception. Human activity factors are also determined and/or otherwise assessed at 324, focusing on the susceptibility of individuals to heat stress based on their activities.

A decision point at 325 checks whether climate change adjustments are necessary. If adjustments are required, the process 320 applies climate change adjustments at 326 to account for projected changes in environmental conditions. Feature engineering at 327 is then performed to refine the data for more accurate scoring. To the extent it is determined at 325 that adjustments are not required, the process 320 proceeds to step 328. It is understood that in at least some embodiments, any decision as to whether climate change adjustments should be applied may be based at least in part on a preference or user choice, e.g., selecting to incorporate climate change adjustments in any determination of heat risk scores. Alternatively, or in addition, climate change adjustments may be applied based on one or more other factors, such as whether it was considered in prior reports, e.g., to facilitate comparisons and/or expectations. In at least some embodiments, climate change adjustments may be applied based on any combination of geographic locations or regions, related human activities and/or occupation(s), anticipated effects of climate change, e.g., anticipated to affect heat risk scores in an observable manner.

The heat risk scores of the defined target regions are calculated at 328 based on the feature-engineered results. Another decision point at 329 determines if the scores are acceptable. If they are, the process generates heat risk score outputs at 330, which can be used to inform and implement strategies for mitigating heat-related risks.

Overall, the example process 320 of FIG. 3B illustrates a comprehensive approach to assessing heat risk, integrating environmental data, human factors, and climate projections to provide actionable insights.

While for purposes of simplicity of explanation, the respective processes 300, 320 are shown and described as a series of blocks in FIGS. 3A and 3B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

The disclosed devices, systems and processes, including the example heat risk assessment system 200, the heat risk scoring systems 210, 240, 260 and heat risk assessment processes 300, 320, of FIGS. 2A, 2B, 2D, 2E, 3A and 3B, delineate a novel methodology for assigning heat risk scores to heat risk assessment areas, regions, facilities. For example, the heat risk scores may be applicable to construction workers, linemen and/or technicians assigned to and/or otherwise operating in wire centers, including areas around the United States that a network operator provides network service to). In at least some embodiments, a resulting risk score applicable to technician heat illness. Traditional heat risk indices, such as the National Weather Service heat risk index and First Street's heat factor index, primarily focus on temperature or heat index measurements. It has been realized that such indices do not fully account for important factors influencing human heat perception and susceptibility to heat stress. The disclosed techniques address such challenges faced with traditional heat metrics, by providing a new methodology that integrates a variety of variables to emphasize those conditions that lead to heat-related illnesses in a workforce exposed to external environmental conditions.

In at least some embodiments the heat risk scores can integrate variables such as solar irradiance, urban heat island effects, and proxies for measuring internal temperature cooling. In at least some embodiments, the heat risk scoring methodologies can contain industry-specific factors, such as worker density, that offer insight into where a workforce may face the hottest temperatures and where such high temperatures would likely place the largest strain on workforce activities and/or operations. In at least some embodiments, variables used in determining heat risk indicators can be selected to ensure they encapsulated as many factors as possible on how the human body reacts to heat in general and/or under those conditions and/or exposure risks posed by different human activities.

In addition to considering the cooling and human capital effects on heat risk, a heat risk scoring process can implement wet-bulb globe temperature (WBGT), e.g., as a primary or main temperature metric. WBGT is considered by the Occupational Safety and Health Administration (OSHA) and the International Organization of Standardization (ISO) to represent a recommended method of measuring environmental heat because it accounts for the effects of radiant heat, e.g., sunlight, furnaces, campfires, on human perception of temperature. In some locations, considering the effects of radiant heat can increase a heat index significantly, e.g., by up to 13.5 F°.

Another benefit of the disclosed risk scoring devices, systems and processes is that it can be leveraged according to short-term and long-term climate risk assessments. While many of the variables considered in a heat risk assessment score can focus on current environmental effects, at least some heat risk scoring can consider how WBGT will likely change entering the mid-21st century and thus provide a dynamic tool for anticipating and managing heat-related risks in the context of evolving climate conditions.

Any organization responsible for organizing, controlling, conducting, monitoring and/or otherwise supporting human activities susceptible to heat risks, such as the technician field operations of a telecommunication and/or other utility service provider would serve as an example benefactor of the disclosed heat risk score. This is particularly true when the heat risk score or index is tailored to measure the risk of a particular group of human actors engaged in a particular human activity, again, the example technicians working on outdoor fiber build installations and repairs.

It is understood that an Environmental Health & Safety (EH&S) organization would also be affected as EH&S is an example of another organization concerned with aligning current workforce policies with best practices for dealing with environmental hazards. EH&S may also use the heat risk score to drive other activities, such as research and development (R&D) efforts and/or collaborations with other companies developing novel technologies and solutions that reduce heat exposure for field technicians. Such technologies might include personal protective gear, hydration products, cooling stations, and so on. Still other organizations that work closely with field operations, such as access construction and engineering, and/or mobility operations that oversee field activities, such as wireline buildouts and wireless infrastructure services, also require outdoor fieldwork and would benefit from the disclosed devices, systems and processes providing heat risk scores. Still other benefactors would include logistics and supply chain, which may benefit from monitoring the heat risk score findings, as the score would inform equipment and materials deployment decisions, ensuring that sensitive operations are not carried out during high-risk periods.

It is envisioned that the disclosed heat risk scoring devices, systems and processes producing heat scores offer universal applicability, essentially being applicable to any industry that requires high labor workloads under hot conditions. The example heat metric includes applications related to a telecommunications company, e.g., by integrating technician-related factors, which would be beneficial to any telecommunications company, e.g., to identify potential vulnerabilities in their outdoor technician workforce. While the example risk scoring show in FIG. 2B assigns risk to domestic regions, it is understood that the methodology can be utilized to develop heat risk scores for international organizations, such as international telecommunications companies.

Virtually human activity, e.g., industry, with actors, e.g., a workforce, that require heavy amounts of outdoor labor will benefit from this heat score as integrating this score into their operations will help company operations make decisions about where to concentrate heat risk mitigation strategies and/or other resources, including equipment. For example, construction workers required to operate heavy machinery, such as jackhammers, sledgehammers, and power saws, are at high risk of heat-related illnesses. Jobs such as masonry, lumbering, mining, and landscaping that require shoveling and stacking heavy building materials like concrete, brick, or lumber place laborers at high risk of heat stress. Industries without outdoor workforces can also benefit from this risk score, as heat-related illnesses can occur indoors just as easily as outdoors. For example, bakers, welders, and warehouse workers who are stationed indoors may still be exposed to heat-related injuries due to a lack of proper air ventilation and heat emanating from indoor appliances. In at least some embodiments, weather data obtained from weather data sources may include internal environmental conditions, such as temperature, humidity, air flow, air circulation, and so on. All these jobs mentioned above could utilize the heat risk score to help identify hot spots in their company's work locations. With the insights from the heat metric, companies can provide the cooling systems and supervisor management necessary to reduce heat-related illnesses, thus protecting their workforces from hazards and death and hardening their labor operations during mass heat events. Even the public service sector would benefit from integrating the heat risk score into their operations, as firefighters, police officers, and emergency medical personnel can use the heat risk score to prepare for and mitigate the risks associated with heat exposure during emergencies.

The disclosed devices, systems and processes for determining heat risk assessments and/or scores align with the pillars of serving customers first and moving faster. To put customers first, a business must be prepared to respond to their needs and concerns promptly. If a business's workforce, e.g., technicians, cannot perform their duties due to physical incapacitation due to extreme temperatures, customer needs may be delayed until new technicians arrive or not be fulfilled to the quality that a business prides itself on. The heat risk score can also help to increase work efficiency as the score can allow the identification of hot spots where heat mitigation strategies could be implemented to maintain high technician productivity.

The heat risk score can also serve to harden a utility service provider's infrastructure, e.g., a network service provider's network infrastructure. Technicians play a key role in the maintenance of network, such that a network service provider benefits from adopting and/or otherwise implementing the disclosed devices, systems and/or processes to harden a workforce's resilience to environmental factors as temperatures continue to increase into the mid-century.

A significant problem addressed by the disclosed devices, systems and processes for determining heat risk scores is reducing outdoor workforce heat-related illnesses. Global warming-induced skyrocketing summer temperatures and increasing heat wave frequencies will expose technicians to higher risk of all sorts of heat illnesses, ranging from minor heat cramps and rash to more severe cases of heat stroke and exhaustion that ultimately can lead to death. The heat risk metric obtained by the disclosed techniques facilitates an identification of which portions of an outdoor workforce may be facing the brunt of heat problems and protect those technicians from heat illness.

The disclosed devices, systems and processes for determining heat risk scores also solve issues of operational efficiency caused by a lack of human fault tolerance during extreme heat conditions during the summer months. For example, workers, e.g., technicians, play an integral role in maintaining the high-quality network service. Proactive recognition of heat risk achievable by the disclosed techniques will address concerns to help keep a workforce, e.g., technicians, healthy and able to quickly troubleshoot and fix network-related issues to keep a network running at its optimal efficiency. The heat risk score can also be used to plan work schedules around peak heat periods to ensure our technicians don't face the fatigue accompanying work in high temperatures.

New regulatory mandates through the OSHA and the National Institute for Occupational Safety and Health (NIOSH) require companies to take heightened precautions surrounding the well-being of their workers. For example, new OSHA regulatory requirements determine work performed over a WBGT of 77 F° unsafe. The disclosed devices, systems and processes for determining heat risk score enable organizations to take proactive measures to identify areas of potential heat vulnerability and reduce their risk of violating local or federal workplace regulations.

Traditionally, heat risk monitoring has been done reactively by monitoring present temperatures and issuing warnings to workers based on temperature-sensing data. These efforts are often done on the morning of a workday, rely on oftentimes inaccurate and spotty sensor data, and do not contain robust methods to identify most vulnerable areas to heat risk illness. Previous attempts have been made to proactively assess heat risk by utilizing generic temperature variables and other temperature-related factors like heat wave duration and the location of the temperature on a distribution. For example, variables considered include an average annual summer daytime hours above WBGT of 78 degrees in a historical period. This variable models how current-day heat affects a workforce, e.g., technicians. It is worth noting here that summer is defined as June, July, and August, with daytime hours defined from 9 am to 6 pm. The historical period can be defined as a period between 1995-2004, which can be used as a baseline for climate science to compare against mid-century climate change situations.

Other variables include percent change in average annual summer daytime hours above WBGT of 78 degrees from historical to mid-century under an RCP 8.5 climate scenario. The climate models can determine how changes in heat may affect different facilities or regions, e.g., network service provider wire centers, in the future. In this regard, a mid-century period can be defined as a period between 2045-2054. The RCP 8.5 represents a climate change scenario in which rising greenhouse gas emissions lead to a 2.0 C° increase in temperatures by the mid-21st century.

Still other variables can include a percentage area of a facility or region, e.g., a wire center for a network service provider, that is considered as an urban area. This variable serves to model what is referred to as an “urban heat island effect.” For example, certain urban areas can experience 7 F° increases in temperature compared to neighboring rural areas. In at least some embodiments, an urban area can be defined by the U.S. Census Bureau's definition of the area that contains at least 2,000 housing units or has a population of at least 5,000.

Other variables can include percentage area of a facility or region, e.g., a wire center for a network service provider, covered by trees. In at least some embodiments, tree cover percentage can be used as a proxy for cooling mechanisms that could provide technician reprieve from warm weather. Tree cover can be defined by a National Land Cover Database (NLCD) Tree Canopy Raster Dataset. For example, values with less than 25% tree coverage percentage can be reclassified as 0% as such areas tend to be urban, also having heavy road density with insufficient tree coverage to be considered effective for cooling.

Still other variables include a number of human actors performing an activity, e.g., technicians performing jobs in a wire center. This variable can help to consider how many actors, workers, e.g., technicians, will be vulnerable in a certain facility or region, e.g., wire center. For example, a wire center with 20 home technicians versus a wire center with 200 home technicians can represent a higher total risk of heat illness. An example work activity for network service providers includes technicians who may be involved in performing fiber optic cable installations or repairs. For a specific wire center, a number considers both technicians assigned to work in that wire center and technicians that are assigned to different wire centers but are “loaned” out to a wire center for jobs. These “wireline” technicians were chosen to represent an outdoor workforce of a network service provider as they tend to be those who are at the highest risk for heat illness since the installation and repair work they perform requires them to be outside for long stretches of time.

Still other variables can include an average duration of an activity, e.g., an average duration of jobs performed by technicians in a wire center. It is generally understood that longer periods spent working on jobs increase the risk of heat-related illnesses. The activity can include jobs performed on fiber optic cable installations as well as wireline equipment that connects customers to a network, e.g., with only those installations and repairs performed outside being considered for this variable.

The heat risk score assigned to a particular facility or region, e.g., a wire center, can have a ranking according to a scale, e.g., from 1 to 4, based on their vulnerability to heat illness. To fully encapsulate the risks of heat illness to an outdoor workforce, the methodology looks at a variety of factors, including temperature, cooling, and technician density factors. The heat risk assessment factors can be chosen according to a feature engineering and/or variable weighting to model different aspects of heat risk illness and serve as an indicator of heat risk and ways that workers can mitigate heat illness. A significant amount of feature engineering may be required before settling on the variables to find the optimal combination of different factors for a particular activity, facility and/or region. For example, when experimenting with using heat index measurements in the score for a telecommunication application, it was observed that a lot of wire centers in Texas tended to be all ranked at similarly high risk. However, when using WBGT, it was observed that wire centers in Western Texas and Western Kansas had lower scores than they previously had when using a heat index metric traditionally implemented in other heat risk indices. The differences could be attributed to the nuances added when using WBGT. A linear regression was also performed on different heat variables to ensure that the heat score's independent variables were not related.

The variable “percent change in average annual summer daytime hours above WBGT of 78 degrees from historical to mid-century under the RCP 8.5 scenario” was also used such that the heat risk assessment results included both present-day and future heat risk. For example, certain wire centers in relatively cooler regions, e.g., Wisconsin and Michigan, that don't currently experience high WBGT hours may see such values triple by the mid-century. Unlike the Southern wire centers that consistently see high temperatures, these Midwestern wire centers could experience an increase in weather conditions that contribute to heat related illness in the mid-century. Educating technicians on the proper heat mitigation strategies may help to minimize heat illness risk.

In at least some embodiments, technician-related factors can be incorporated into the risk score, as it is envisioned that oftentimes facilities that experience extremely high temperature readings may have a relatively low number or volume of human actor or worker activity. Since the heat risk scores inherently track human risk, it can be beneficial to assign lower scores for facilities with extremely high temperatures but low worker workloads.

Variables can be weighted differently based on their relative importance to a final heat risk assessment or score. Since the score's main goal is to identify heat-related risk, the variables related to temperature, e.g., summer working hours above 78 WBGT and percent change in summer working hours above 78 WBGT from historical to mid-century RCP 8.5, can be weighted the highest. In at least some embodiments, average job duration can be weighted heavier because of the strong correlation between heat risk and long exposures to high temperatures. In at least some embodiments, the tree cover percentage can be weighted lower than at least some of the other variables because it represents one single potential cooling technique whereas many other methods to decrease body temperature exist.

In at least some embodiments, a risk scoring methodology includes obtaining and/or otherwise configured according to one or more of the variables according to raster data. Raster data is a type of spatial data representation that consists of a grid of cells or pixels, where each cell contains a value representing information about a specific geographic area. This data format is commonly used to represent continuous phenomena, such as temperature, elevation, precipitation, or land cover, where each cell value corresponds to a specific measurement or classification at that location. Raster data is characterized by its resolution, which is determined by the size of the cells; higher resolution rasters have smaller cells and provide more detailed information. This format is widely used in geographic information systems (GIS) and remote sensing applications to analyze and visualize spatial patterns and trends across large areas.

After collecting and/or configurating the variable data according to the rasters for those variables contributing to a heat risk score, the rasters can be clipped, interpolated and/or otherwise referenced to boundaries of the of the facilities and/or regions being examined. By way of example, the ArcGIS geographic information system software developed by ESRI weas used to clip the rastered data to the regions of interest, e.g., wire centers. The ArcGIS software provides tools for performing complex spatial analyses, such as proximity analysis, overlay analysis, and network analysis, to derive insights from geographic data. Next, the average was obtained for the variables according to regions of interest, e.g., wire centers. Minimum-maximum normalization was then applied on each variable, e.g., to scale the different variables to a common range. A weighted mean of the variables can be obtained and used to create a percentile list of the regions of interest based on the weighted mean. In at least some embodiments, the resulting processed values can be assigned a score, e.g., of 1 (lowest risk) to 4 (highest risk) based on the quartile of the wire centers' weighted averages.

The example methodology has been observed to outperform past attempts because past methods do not consider human-related factors and thus have difficulty applying risk to industry-specific workforces. They also often do not consider cooling factors and often over-emphasize the effects of temperature on heat risk. The other methods also do not adhere to the newest OSHA/NIOSH standards like using Wet-Bulb Globe Temperature. Our score also considers future temperature values into the mid-century unlike many other attempts that only consider current-day risk and at the most, only predict risk a few weeks into the future.

By accurately assessing heat risk, the example devices, systems and processes can help implement better safety measures for workers, e.g., technicians, working in the field. Having a more reliable insight into heat risks supports reducing heat-related illnesses and/or injuries, leading to fewer worker compensation claims and improved workforce productivity. This heat risk index can be used as evidence to fund the need for new heat-sensing technology. The resulting heat risk score can also be integrated into Job Hazard Analyses (JHA), an OSHA-recommended procedure to identify and eliminate hazards in the workplace. Currently, JHAs don't consider environmental factors. Adding the heat risk score assessment to the JHAs could provide more funding opportunities for Personal Protective Equipment, installing cooling devices in technician vans, and other heat mitigation strategies.

The disclosed devices, systems and processes for identifying, predicting, reporting and/or managing heat risk facilitate operational efficiency of any group or organization exposed to environmental conditions capable of heat-induced stress. With precise heat risk assessments, activity, e.g., work schedules and tasks can be managed and, in at least some scenarios, optimized to avoid peak heat times, thus reducing downtime and improving overall operational efficiency. Extreme heat and humidity can also increase fatigue and decrease a technician's ability to work efficiently. While extreme heat requires workers to take more breaks, they are paramount in ensuring that workers can operate at their highest capability and stay resilient to potentially crippling heat illness.

The disclosed devices, systems and processes facilitate cost savings, e.g., by integrating localized data that helps prevent heat-related equipment failures and/or service disruptions. This leads to cost savings in maintenance and emergency response. In at least some embodiments, the heat risk can be applied to non-human activity and/or equipment. For example, electric wiring is responsive to temperature changes and increases in temperatures can cause wire overheating, insulator degradation, and thermal expansion. All these consequences can lead to potential hazards like fires, loss of power, and electrocution. Proactively staying on top of these areas prone to heat-related electrical problems will allow a network and/or electrical utility service provider to quickly respond to potential electrical hazards and reduce any related damage costs.

The disclosed devices, systems and processes can provide a competitive advantage, e.g., by utilizing advanced, data-driven risk assessments. Such advantages can position an adopter to establish themselves as a leader in innovative safety practices within any related field and/or industry. It is envisioned that such advantages can enhance a company's reputation and potentially attract new business opportunities.

Still other advantages include promoting regulatory compliance, by monitoring and/or predicting operating conditions and adhering to stringent safety standards and regulations. This heat risk score system can help any adopter to ensure compliance with occupational safety regulations created by OSHA and NIOSH, reducing the risk of legal penalties. Still further advantages include reliably supporting enhanced safety protocols, e.g., by providing a reliable tool to assess and mitigate heat-related risks. The disclosed devices, systems and processes also support data-driven decision making, e.g., by leveraging localized data and environmental metrics that empower an adopter to make informed decisions regarding field operations.

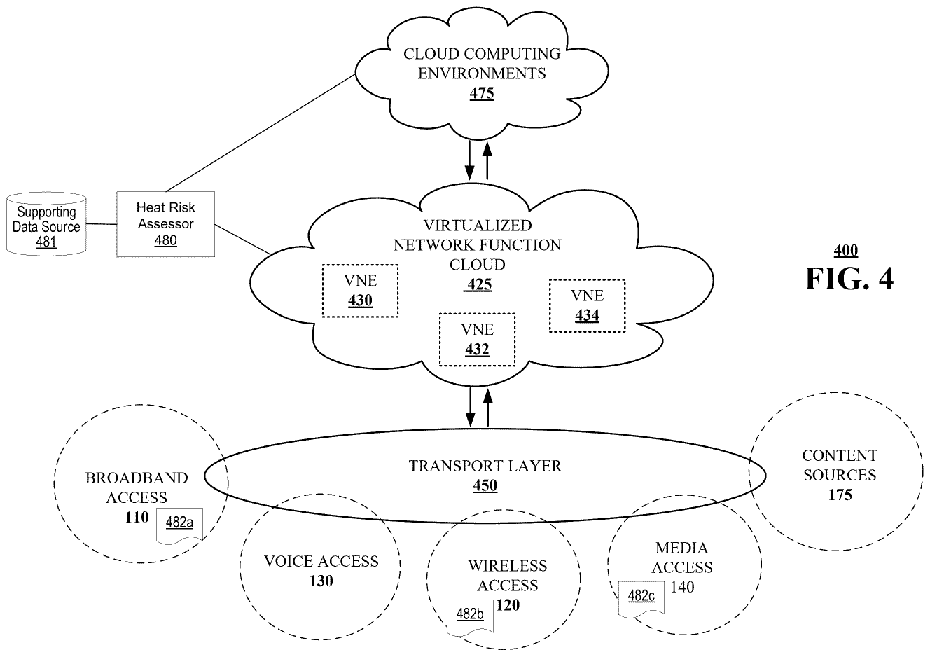

Referring now to FIG. 4, a block diagram is shown illustrating an example, non-limiting embodiment of a virtualized communication network 400 in accordance with various aspects described herein. In particular a virtualized communication network is presented that can be used to implement some or all of the subsystems and functions of the communications system 100, the subsystems and functions of systems 200, 210, 240, 260, 400 and processes 300 and 320 presented in FIGS. 1, 2A, 2B, 2D, 2E, 3A, 3B and 4. For example, virtualized communication network 400 can facilitate in whole or in part evaluating heat-related risks for individuals engaged in outdoor activities based on wet-bulb globe temperature and climate data. In at least some embodiments, the heat risk assessment leverages artificial intelligence and/or machine learning (AI/ML) to dynamically evaluate and manage the heat-related risks, thereby enhancing safety and operational efficiency.

In particular, a cloud networking architecture is shown that leverages cloud technologies and supports rapid innovation and scalability via a transport layer 450, a virtualized network function cloud 425 and/or one or more cloud computing environments 475. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 430, 432, 434, etc., that perform some or all of the functions of network elements 150, 152, 154, 156, etc., For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 430 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 450 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. At other times, the network elements have specific physical layer adapters that cannot be abstracted or virtualized and might require special DSP code and analog front ends (AFEs) that do not lend themselves to implementation as VNEs 430, 432 or 434. These network elements can be included in transport layer 450.

The virtualized network function cloud 425 interfaces with the transport layer 450 to provide the VNEs 430, 432, 434, etc., to provide specific NFVs. In particular, the virtualized network function cloud 425 leverages cloud operations, applications, and architectures to support networking workloads. The virtualized network elements 430, 432 and 434 can employ network function software that provides either a one-for-one mapping of traditional network element function or alternately some combination of network functions designed for cloud computing. For example, VNEs 430, 432 and 434 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 430, 432, 434, etc., can be instantiated and managed using an orchestration approach similar to those used in cloud compute services.

The cloud computing environments 475 can interface with the virtualized network function cloud 425 via APIs that expose functional capabilities of the VNEs 430, 432, 434, etc., to provide the flexible and expanded capabilities to the virtualized network function cloud 425. In particular, network workloads may have applications distributed across the virtualized network function cloud 425 and cloud computing environment 475 and in the commercial cloud or might simply orchestrate workloads supported entirely in NFV infrastructure from these third-party locations.

The example virtualized communication network 400 incorporates and/or otherwise facilitates operation of a heat risk assessor 480, which, in turn, is in communication with one or more supporting heat risk assessment data sources 481. In at least some embodiments, the heat risk assessor 480 is configured to include a processing system having one or more processors configured to process data obtained from the one or more supporting data sources 481 and to determine from the processed data heat risk assessments including one or more indicators of heat risk to one or more human activities. Without limitation, the one or more supporting data sources can provide one or more of weather data, human activity data, geographic locations and/or proximities associated with one or more of the weather data and/or the human activity data. It is envisioned that in at least some embodiments, the heat risk assessments may include a rating and/or a score, such as an index score. For example, an index score may include a limited number of scores to simplify interpretation by consumers of such information. It is envisioned that in at least some embodiments, interpretation may include an action plan that may be based upon a heat assessment score index. By way of example, an action plan may determine a maximum permissible length of time for a particular activity based on the heat assessment score index. Alternatively, or in addition, such an action plan may determine which human activities of a range of activities may be permissible and/or prohibited according to the heat assessment score index. In at least some embodiments, the action plan may identify countermeasures, such as protective gear, cooling gear, hydration plan, and the like.

The supporting one or more supporting heat risk assessment data sources can include environmental data, such as terrain data, facilities data and/or weather-related data. Terrain data may include, without limitation, elevation data, soil content/type data, vegetation data, e.g., tree-cover, and urban coverage. Facilities data can include, without limitation, proximity to manmade shade providers, access to environmentally controlled areas, e.g., air-conditioned areas, and so on. Weather-related data can include, without limitation, one or more of air temperature, solar radiance, humidity, cloud-cover, precipitation, and the like.

It is envisioned that in at least some embodiments, the heat risk assessor 480 may be in communication with consumer systems and/or devices via a network, such as via one or more of the example virtualized network function cloud 425, the example broadband access network 110, the example wireless access network 120, the example voice access network 130 and/or the example media access network 140. The consumer systems, without limitation, can include one or more of the aforementioned devices, e.g., which may be configured to include and/or otherwise support operation of a heat risk assessment application program or app 482a, 482b, 482c, generally 482. The heat risk assessment app 482 can be configured to cooperate with the heat risk assessor 480 to provide data to the heat risk assessor 480, and/or to configure a heat risk assessment process implemented by the heat risk assessor 480 and/or to access heat risk assessment results, e.g., heat assessment score index data.

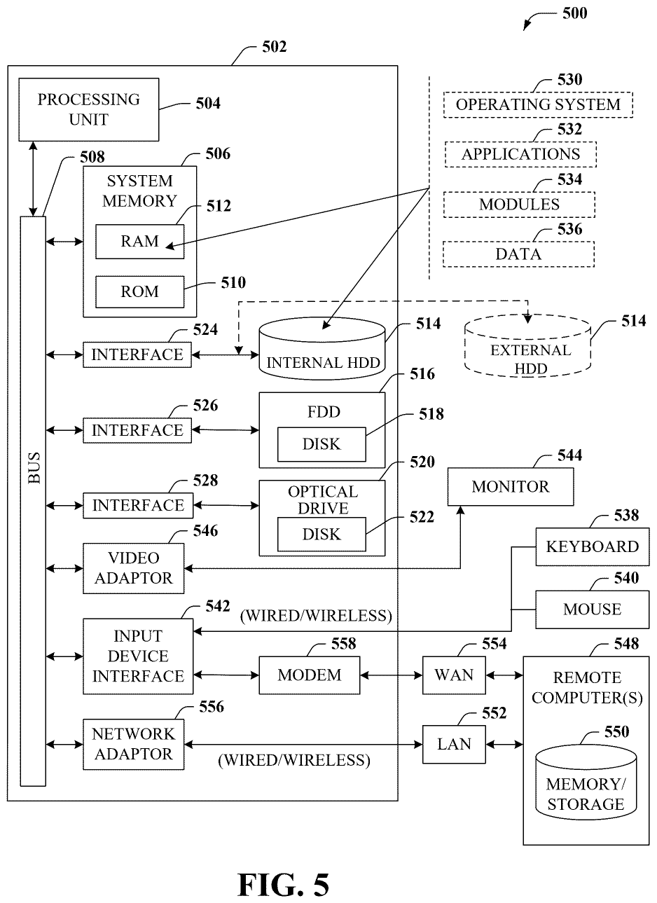

Turning now to FIG. 5, there is illustrated a block diagram of a computing environment in accordance with various aspects described herein. In order to provide additional context for various embodiments of the embodiments described herein, FIG. 5 and the following discussion are intended to provide a brief, general description of a suitable computing environment 500 in which the various embodiments of the subject disclosure can be implemented. In particular, computing environment 500 can be used in the implementation of network elements 150, 152, 154, 156, access terminal 112, base station or access point 122, switching device 132, media terminal 142, and/or VNEs 430, 432, 434, etc., Each of these devices can be implemented via computer-executable instructions that can run on one or more computers, and/or in combination with other program modules and/or as a combination of hardware and software. For example, computing environment 500 can facilitate in whole or in part evaluating heat-related risks for individuals engaged in outdoor activities based on wet-bulb globe temperature and climate data. In at least some embodiments, the heat risk assessment leverages artificial intelligence and/or machine learning (AI/ML) to dynamically evaluate and manage the heat-related risks, thereby enhancing safety and operational efficiency.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 5, the example environment can comprise a computer 502, the computer 502 comprising a processing unit 504, a system memory 506 and a system bus 508. The system bus 508 couples system components including, but not limited to, the system memory 506 to the processing unit 504. The processing unit 504 can be any of various commercially available processors. Dual microprocessors and other multiprocessor architectures can also be employed as the processing unit 504.

The system bus 508 can be any of several types of bus structure that can further interconnect to a memory bus (with or without a memory controller), a peripheral bus, and a local bus using any of a variety of commercially available bus architectures. The system memory 506 comprises ROM 510 and RAM 512. A basic input/output system (BIOS) can be stored in a non-volatile memory such as ROM, erasable programmable read only memory (EPROM), EEPROM, which BIOS contains the basic routines that help to transfer information between elements within the computer 502, such as during startup. The RAM 512 can also comprise a high-speed RAM such as static RAM for caching data.

The computer 502 further comprises an internal hard disk drive (HDD) 514 (e.g., EIDE, SATA), which internal HDD 514 can also be configured for external use in a suitable chassis (not shown), a magnetic floppy disk drive (FDD) 516, (e.g., to read from or write to a removable diskette 518) and an optical disk drive 520, (e.g., reading a CD-ROM disk 522 or, to read from or write to other high-capacity optical media such as the DVD). The HDD 514, magnetic FDD 516 and optical disk drive 520 can be connected to the system bus 508 by a hard disk drive interface 524, a magnetic disk drive interface 526 and an optical drive interface 528, respectively. The hard disk drive interface 524 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 502, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 512, comprising an operating system 530, one or more application programs 532, other program modules 534 and program data 536. All or portions of the operating system, applications, modules, and/or data can also be cached in the RAM 512. The systems and methods described herein can be implemented utilizing various commercially available operating systems or combinations of operating systems.

A user can enter commands and information into the computer 502 through one or more wired/wireless input devices, e.g., a keyboard 538 and a pointing device, such as a mouse 540. Other input devices (not shown) can comprise a microphone, an infrared (IR) remote control, a joystick, a game pad, a stylus pen, touch screen or the like. These and other input devices are often connected to the processing unit 504 through an input device interface 542 that can be coupled to the system bus 508, but can be connected by other interfaces, such as a parallel port, an IEEE 1394 serial port, a game port, a universal serial bus (USB) port, an IR interface, etc.

A monitor 544 or other type of display device can be also connected to the system bus 508 via an interface, such as a video adapter 546. It will also be appreciated that in alternative embodiments, a monitor 544 can also be any display device (e.g., another computer having a display, a smart phone, a tablet computer, etc.) for receiving display information associated with computer 502 via any communication means, including via the Internet and cloud-based networks. In addition to the monitor 544, a computer typically comprises other peripheral output devices (not shown), such as speakers, printers, etc.

The computer 502 can operate in a networked environment using logical connections via wired and/or wireless communications to one or more remote computers, such as a remote computer(s) 548. The remote computer(s) 548 can be a workstation, a server computer, a router, a personal computer, portable computer, microprocessor-based entertainment appliance, a peer device or other common network node, and typically comprises many or all of the elements described relative to the computer 502, although, for purposes of brevity, only a remote memory/storage device 550 is illustrated. The logical connections depicted comprise wired/wireless connectivity to a local area network (LAN) 552 and/or larger networks, e.g., a wide area network (WAN) 554. Such LAN and WAN networking environments are commonplace in offices and companies, and facilitate enterprise-wide computer networks, such as intranets, all of which can connect to a global communications network, e.g., the Internet.

When used in a LAN networking environment, the computer 502 can be connected to the LAN 552 through a wired and/or wireless communication network interface or adapter 556. The adapter 556 can facilitate wired or wireless communication to the LAN 552, which can also comprise a wireless AP disposed thereon for communicating with the adapter 556.

When used in a WAN networking environment, the computer 502 can comprise a modem 558 or can be connected to a communications server on the WAN 554 or has other means for establishing communications over the WAN 554, such as by way of the Internet. The modem 558, which can be internal or external and a wired or wireless device, can be connected to the system bus 508 via the input device interface 542. In a networked environment, program modules depicted relative to the computer 502 or portions thereof can be stored in the remote memory/storage device 550. It will be appreciated that the network connections shown are example and other means of establishing a communications link between the computers can be used.

The computer 502 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

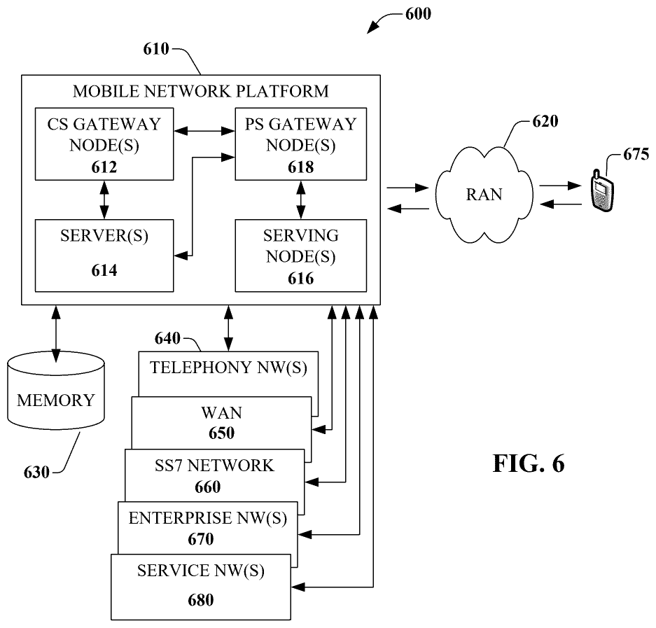

Turning now to FIG. 6, an embodiment 600 of a mobile network platform 610 is shown that is an example of network elements 150, 152, 154, 156, and/or VNEs 430, 432, 434, etc. For example, platform 610 can facilitate in whole or in part evaluating heat-related risks for individuals engaged in outdoor activities based on wet-bulb globe temperature and climate data. In at least some embodiments, the heat risk assessment leverages artificial intelligence and/or machine learning (AI/ML) to dynamically evaluate and manage the heat-related risks, thereby enhancing safety and operational efficiency. In one or more embodiments, the mobile network platform 610 can generate and receive signals transmitted and received by base stations or access points such as base station or access point 122. Generally, mobile network platform 610 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 610 can be included in telecommunications carrier networks and can be considered carrier-side components as discussed elsewhere herein. Mobile network platform 610 comprises CS gateway node(s) 612 which can interface CS traffic received from legacy networks like telephony network(s) 640 (e.g., public switched telephone network (PSTN), or public land mobile network (PLMN)) or a signaling system #7 (SS7) network 660. CS gateway node(s) 612 can authorize and authenticate traffic (e.g., voice) arising from such networks. Additionally, CS gateway node(s) 612 can access mobility, or roaming, data generated through SS7 network 660; for instance, mobility data stored in a visited location register (VLR), which can reside in memory 630. Moreover, CS gateway node(s) 612 interfaces CS-based traffic and signaling and PS gateway node(s) 618. As an example, in a 3GPP UMTS network, CS gateway node(s) 612 can be realized at least in part in gateway GPRS support node(s) (GGSN). It should be appreciated that functionality and specific operation of CS gateway node(s) 612, PS gateway node(s) 618, and serving node(s) 616, is provided and dictated by radio technology(ies) utilized by mobile network platform 610 for telecommunication over a radio access network 620 with other devices, such as a radiotelephone 675.

In addition to receiving and processing CS-switched traffic and signaling, PS gateway node(s) 618 can authorize and authenticate PS-based data sessions with served mobile devices. Data sessions can comprise traffic, or content(s), exchanged with networks external to the mobile network platform 610, like wide area network(s) (WANs) 650, enterprise network(s) 670, and service network(s) 680, which can be embodied in local area network(s) (LANs), can also be interfaced with mobile network platform 610 through PS gateway node(s) 618. It is to be noted that WANs 650 and enterprise network(s) 670 can embody, at least in part, a service network(s) like IP multimedia subsystem (IMS). Based on radio technology layer(s) available in technology resource(s) or radio access network 620, PS gateway node(s) 618 can generate packet data protocol contexts when a data session is established; other data structures that facilitate routing of packetized data also can be generated. To that end, in an aspect, PS gateway node(s) 618 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 600, mobile network platform 610 also comprises serving node(s) 616 that, based upon available radio technology layer(s) within technology resource(s) in the radio access network 620, convey the various packetized flows of data streams received through PS gateway node(s) 618. It is to be noted that for technology resource(s) that rely primarily on CS communication, server node(s) can deliver traffic without reliance on PS gateway node(s) 618; for example, server node(s) can embody at least in part a mobile switching center. As an example, in a 3GPP UMTS network, serving node(s) 616 can be embodied in serving GPRS support node(s) (SGSN).

For radio technologies that exploit packetized communication, server(s) 614 in mobile network platform 610 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 610. Data streams (e.g., content(s) that are part of a voice call or data session) can be conveyed to PS gateway node(s) 618 for authorization/authentication and initiation of a data session, and to serving node(s) 616 for communication thereafter. In addition to application server, server(s) 614 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 610 to ensure network's operation and data integrity in addition to authorization and authentication procedures that CS gateway node(s) 612 and PS gateway node(s) 618 can enact. Moreover, provisioning server(s) can provision services from external network(s) like networks operated by a disparate service provider; for instance, WAN 650 or Global Positioning System (GPS) network(s) (not shown). Provisioning server(s) can also provision coverage through networks associated with mobile network platform 610 (e.g., deployed and operated by the same service provider), such as the distributed antennas networks shown in FIG. 1(s) that enhance wireless service coverage by providing more network coverage.

It is to be noted that server(s) 614 can comprise one or more processors configured to confer at least in part the functionality of mobile network platform 610. To that end, the one or more processors can execute code instructions stored in memory 630, for example. It should be appreciated that server(s) 614 can comprise a content manager, which operates in substantially the same manner as described hereinbefore.

In example embodiment 600, memory 630 can store information related to operation of mobile network platform 610. Other operational information can comprise provisioning information of mobile devices served through mobile network platform 610, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 630 can also store information from at least one of telephony network(s) 640, WAN 650, SS7 network 660, or enterprise network(s) 670. In an aspect, memory 630 can be, for example, accessed as part of a data store component or as a remotely connected memory store.

In order to provide a context for the various aspects of the disclosed subject matter, FIG. 6, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc., that perform particular tasks and/or implement particular abstract data types.

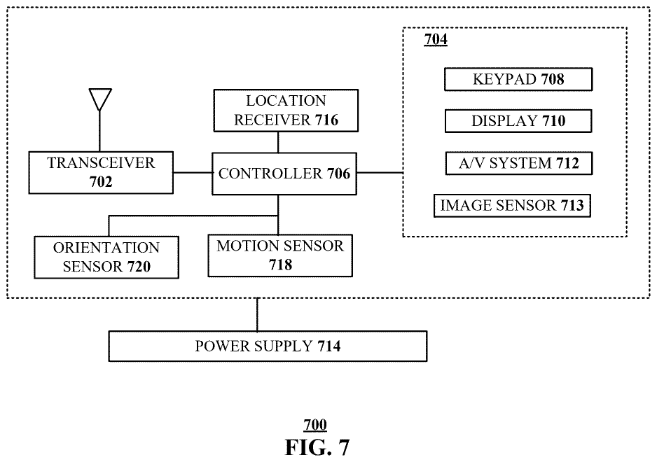

Turning now to FIG. 7, an illustrative embodiment of a communication device 700 is shown. The communication device 700 can serve as an illustrative embodiment of devices such as data terminals 114, mobile devices 124, vehicle 126, display devices 144 or other client devices for communication via either communications network 125. For example, computing device 700 can facilitate in whole or in part evaluating heat-related risks for individuals engaged in outdoor activities based on wet-bulb globe temperature and climate data. In at least some embodiments, the heat risk assessment leverages artificial intelligence and/or machine learning (AI/ML) to dynamically evaluate and manage the heat-related risks, thereby enhancing safety and operational efficiency.

The communication device 700 can comprise a wireline and/or wireless transceiver 702 (herein transceiver 702), a user interface (UI) 704, a power supply 714, a location receiver 716, a motion sensor 718, an orientation sensor 720, and a controller 706 for managing operations thereof. The transceiver 702 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 702 can also be adapted to support circuit-switched wireline access technologies (such as PSTN), packet-switched wireline access technologies (such as TCP/IP, VoIP, etc.), and combinations thereof.

The UI 704 can include a depressible or touch-sensitive keypad 708 with a navigation mechanism such as a roller ball, a joystick, a mouse, or a navigation disk for manipulating operations of the communication device 700. The keypad 708 can be an integral part of a housing assembly of the communication device 700 or an independent device operably coupled thereto by a tethered wireline interface (such as a USB cable) or a wireless interface supporting for example Bluetooth^{®}. The keypad 708 can represent a numeric keypad commonly used by phones, and/or a QWERTY keypad with alphanumeric keys. The UI 704 can further include a display 710 such as monochrome or color LCD (Liquid Crystal Display), OLED (Organic Light Emitting Diode) or other suitable display technology for conveying images to an end user of the communication device 700. In an embodiment where the display 710 is touch-sensitive, a portion or all of the keypad 708 can be presented by way of the display 710 with navigation features.

The display 710 can use touch screen technology to also serve as a user interface for detecting user input. As a touch screen display, the communication device 700 can be adapted to present a user interface having graphical user interface (GUI) elements that can be selected by a user with a touch of a finger. The display 710 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 710 can be an integral part of the housing assembly of the communication device 700 or an independent device communicatively coupled thereto by a tethered wireline interface (such as a cable) or a wireless interface.

The UI 704 can also include an audio system 712 that utilizes audio technology for conveying low volume audio (such as audio heard in proximity of a human ear) and high-volume audio (such as speakerphone for hands free operation). The audio system 712 can further include a microphone for receiving audible signals of an end user. The audio system 712 can also be used for voice recognition applications. The UI 704 can further include an image sensor 713 such as a charged coupled device (CCD) camera for capturing still or moving images.

The power supply 714 can utilize common power management technologies such as replaceable and rechargeable batteries, supply regulation technologies, and/or charging system technologies for supplying energy to the components of the communication device 700 to facilitate long-range or short-range portable communications. Alternatively, or in combination, the charging system can utilize external power sources such as DC power supplied over a physical interface such as a USB port or other suitable tethering technologies.

The location receiver 716 can utilize location technology such as a global positioning system (GPS) receiver capable of assisted GPS for identifying a location of the communication device 700 based on signals generated by a constellation of GPS satellites, which can be used for facilitating location services such as navigation. The motion sensor 718 can utilize motion sensing technology such as an accelerometer, a gyroscope, or other suitable motion sensing technology to detect motion of the communication device 700 in three-dimensional space. The orientation sensor 720 can utilize orientation sensing technology such as a magnetometer to detect the orientation of the communication device 700 (north, south, west, and east, as well as combined orientations in degrees, minutes, or other suitable orientation metrics).

The communication device 700 can use the transceiver 702 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 706 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 700.

Other components not shown in FIG. 7 can be used in one or more embodiments of the subject disclosure. For instance, the communication device 700 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.,

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or non-volatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.,

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
receiving, by a processing system including a processor, rasterized weather data spanning a geographical region;
determining, by the processing system, rasterized wet-bulb globe temperature (WBGT) data based on the rasterized weather data;
identifying, by the processing system, a plurality of boundaries defining a plurality of work regions occurring within the geographical region of interest, wherein the work regions are associated with a human activity;
clipping, by the processing system, the rasterized weather data comprising the WBGT data to the plurality of boundaries of the plurality of work regions to obtain clipped weather data comprising the WBGT data;
determining, by the processing system, a heat risk offset data according to the human activity and associated with the plurality of work regions;
determining, by the processing system, heat risk factors associated with the plurality of work regions and based on the clipped weather data comprising the WBGT and the heat risk offset data;
combining, by the processing system, the heat risk factors to obtain a combined heat risk factor; and
generating, by the processing system, heat risk scores based on the combined heat risk factors.

2. The method of claim 1, wherein the determining the rasterized WBGT data further comprises:
estimating, by the processing system, performance of at least one of dry-bulb thermometer readings, natural wet-bulb thermometer readings, and black-globe thermometer readings, wherein the WBGT is based on a weighted combination of the dry-bulb thermometer readings, the natural wet-bulb thermometer readings and the black-globe thermometer readings.

3. The method of claim 1, wherein the rasterized weather data comprises the WBGT data.

4. The method of claim 1, wherein the heat risk offset data comprises worker-related data, and further comprising:
performing, by the processing system, minimum-maximum normalization on the clipped weather data and worker-related data to yield normalized variables; and
calculating, by the processing system, a weighted mean of the normalized variables using predetermined weights that emphasize both temperature exposure and worker-related factors, wherein the combined heat risk factor is based on the weighted mean of the normalized variables.

5. The method of claim 4, wherein the generating the heat risk scores further comprises:
assigning, by the processing system, a respective one of the heat risk scores to each work region based on a quartile ranking of the weighted mean of the normalized variables.

6. The method of claim 1, further comprising:
generating, by the processing system, an output report comprising the heat risk scores for use in informing and implementing heat risk mitigation strategies.

7. The method of claim 1, further comprising:
predicting, by the processing system, a climate-change condition; and
estimating, by the processing system, the rasterized weather data to obtain rasterized climate-change weather data, wherein the clipped weather data comprises clipped climate-change weather data.

8. The method of claim 1, wherein the data according to the human activity further includes a number of workers assigned to each work region.

9. The method of claim 1, further comprising:
determining, by the processing system, a portion of the plurality of work regions considered to be urban; and
adjusting, by the processing system, the heat risk offset data to incorporate an urban heat island effect based on portion of the plurality of work regions considered to be urban.

10. The method of claim 9, further comprising:
determining, by the processing system, a portion of the plurality of work regions considered to be covered by trees; and
adjusting, by the processing system, the heat risk offset data to incorporate canopy effect based on portion of the plurality of work regions considered to be covered by trees.

11. The method of claim 1, further comprising:
applying, by the processing system, artificial intelligence to one or more of the determining of the heat risk factors, the combining the heat risk factors to obtain a combined heat risk factor, the generating of the heat risk scores based on the combined heat risk factors, or the generating of the heat risk scores based on the combined heat risk factors.

12. The method of claim 11, further comprising:
applying, by the processing system, feature engineering to one or more of the determining of the heat risk factors, the combining of the heat risk factors to obtain a combined heat risk factor, the generating of the heat risk scores based on the combined heat risk factors, or the generating of the heat risk scores based on the combined heat risk factors.

13. A device, comprising:
processing system including a processor; and
a memory that stores executable instructions that, when executed by the processing system, facilitate performance of operations, the operations comprising:
obtaining rasterized weather data spanning a geographical region;
determining rasterized wet-bulb globe temperature (WBGT) data based on the rasterized weather data;
determining a plurality of activity regions defined by a plurality of boundaries occurring within the geographical region, wherein the activity regions are associated with a human activity;
adjusting the rasterized weather data comprising the WBGT data to the plurality of boundaries of the plurality of activity regions to obtain activity-region-adjusted weather data comprising the WBGT data;
determining heat risk offset data according to the human activity and associated with the plurality of activity regions;
determining heat risk factors associated with the plurality of activity regions and based on the activity-region-adjusted weather data comprising the WBGT and the heat risk offset data;
combining the heat risk factors to obtain a combined heat risk factor; and
generating heat risk scores based on the combined heat risk factors.

14. The device of claim 13, wherein the heat risk offset data comprises activity-related data, and wherein the operations further comprise:
performing minimum-maximum normalization on the activity-region-adjusted weather data and worker-related data to yield normalized variables; and
calculating a weighted mean of the normalized variables using predetermined weights that emphasize both temperature exposure and worker-related factors, wherein the combined heat risk factor is based on the weighted mean of the normalized variables.

15. The device of claim 14, wherein the generating the heat risk scores further comprises:
assigning, by the processing system, a respective one of the heat risk scores to each activity region based on a quartile ranking of the weighted mean of the normalized variables.

16. The device of claim 13, wherein the operations further comprise:
predicting a climate-change condition; and
estimating the rasterized weather data to obtain rasterized climate-change weather data, wherein the activity-region-adjusted weather data comprises activity-region-adjusted climate-change weather data.

17. The device of claim 13, wherein the operations further comprise:
determining a portion of the plurality of activity regions considered to be urban; and
adjusting the heat risk offset data to incorporate an urban heat island effect based on portion of the plurality of activity regions considered to be urban.

18. The device of claim 13, wherein the operations further comprise:
determining, a portion of the plurality of activity regions considered to be covered by trees; and
adjusting the heat risk offset data to incorporate canopy effect based on portion of the plurality of activity regions considered to be covered by trees.

19. A non-transitory machine-readable medium, comprising executable instructions that, when executed by a processing system including a processor, facilitate performance of operations, the operations comprising:
obtaining rasterized weather data spanning a geographical region;
associating rasterized wet-bulb globe temperature (WBGT) data based on the rasterized weather data with a geographic grid;
determining a plurality of activity regions defined by a plurality of boundaries occurring within the geographical grid, wherein the activity regions are associated with an activity;
adjusting the rasterized weather data comprising the WBGT data to the plurality of boundaries of the plurality of activity regions to obtain activity-region-adjusted weather data comprising the WBGT data;
determining heat risk offset data according to the activity and associated with the plurality of activity regions;
determining heat risk factors associated with the plurality of activity regions and based on the activity-region-adjusted weather data comprising the WBGT and the heat risk offset data; and
combining the heat risk factors to obtain a heat risk score.

20. The non-transitory machine-readable medium of claim 19, wherein the operations further comprise:
predicting a climate-change condition;
estimating the rasterized weather data to obtain rasterized climate-change weather data, wherein the activity-region-adjusted weather data comprises activity-region-adjusted climate-change weather data;
determining a portion of the plurality of activity regions considered to be urban;
adjusting the heat risk offset data to incorporate an urban heat island effect based on portion of the plurality of activity regions considered to be urban;
determining, a portion of the plurality of activity regions considered to be covered by trees; and
adjusting the heat risk offset data to incorporate canopy effect based on portion of the plurality of activity regions considered to be covered by trees.
